(19) United States
(12) Patent Application Publication
(10) Pub. No.: US 2015/0046878 A1
(43) Pub. Date: Feb. 12, 2015

(54) INFORMATION PROCESSING APPARATUS AND INFORMATION PROCESSING METHOD

(71) Applicants: SONY ELECTRONICS INC., Parkridge, NJ (US); SONY CORPORATION, Tokyo (JP)

(72) Inventors: Yasuhiro SUTOU, Tokyo (JP); Hiroaki KITANO, Saitama (JP); Hirokazu SHIRADO, Tokyo (JP); Steven FRIEDLANDER, San Diego, CA (US); David YOUNG, San Diego, CA (US); Koichi OSHIMA, Tokyo (JP); Yasuo SAKUMA, Kanagawa (JP)

(73) Assignees: SONY ELECTRONICS INC., Parkridge, NJ (US); SONY CORPORATION, Tokyo (JP)

(21) Appl. No.: 13/962,053

(22) Filed: Aug. 8, 2013

(51) Int. Cl. G06F 3/0481

(52) U.S. Cl. CPC G06F 3/04817
USPC 715/835

(57) ABSTRACT

There is provided an information processing apparatus including a content information acquisition part configured to acquire pieces of content information extracted based on an extraction condition, and a display controller configured to cause content icons corresponding to the pieces of content information, respectively, to be displayed on a track placed around a region. In a first display stage, the display controller causes the content icons to be displayed sequentially on a first track in a manner that the content icons appear at a first point on the first track and disappear at a second point on the first track, the second point being different from the first point, and, in a second display stage, the display controller causes a predetermined number of the content icons corresponding to the pieces of content information, respectively, to be displayed on a second track.

### BACKGROUND

The present disclosure relates to an information processing apparatus and an information processing method.

In recent years, an information processing apparatus has been generally used by being connected to other information processing apparatuses via a network in a state of being communicable with each other. Users of the information processing apparatus can access a tremendous amount of information via the network, but on the other hand, it becomes necessary to perform an operation of extracting desired information from those pieces of information. Accordingly, various types of systems are suggested, which manage diverse pieces of information that exist in the network, which also extract information matching an extraction condition from those pieces of information, and which provide a user with the extracted information.

### SUMMARY

In light of the foregoing, it is desirable to provide an information processing apparatus and an information processing method, which are novel and improved, and which are capable of enhancing viewability of information shown to a user.

According to an embodiment of the present disclosure, there is provided an information processing apparatus which includes a content information acquisition part configured to acquire pieces of content information extracted based on an extraction condition, and a display controller configured to cause content icons corresponding to the pieces of content information, respectively, to be displayed on a track placed around a region. In a first display stage, the display controller causes the content icons to be displayed sequentially on a first track in a manner that the content icons appear at a first point on the first track and disappear at a second point on the first track, the second point being different from the first point, and, in a second display stage, the display controller causes a predetermined number of the content icons corresponding to the pieces of content information, respectively, to be displayed on a second track.

According to another embodiment of the present disclosure, there is provided an information processing method which includes acquiring pieces of content information extracted based on an extraction condition, causing content icons corresponding to the pieces of content information, respectively, to be displayed on a track placed around a region, causing, in a first display stage, the content icons to be displayed sequentially on a first track in a manner that the content icons appear at a first point on the first track and disappear at a second point on the first track, the second point being different from the first point, and causing, in a second display stage, a predetermined number of the content icons corresponding to the pieces of content information, respectively, to be displayed on a second track.

According to one or more of embodiments described above, it becomes possible to enhance viewability of information shown to a user.

### BRIEF DESCRIPTION OF THE DRAWINGS

FIG. 1 is a functional block diagram showing a schematic configuration of functions of a content distribution system according to an embodiment of the present disclosure;

FIG. 2A is a diagram showing a display example of a content information extraction GUI according to the present embodiment;

FIG. 2B is a diagram showing a display example of the content information extraction GUI according to the present embodiment;

FIG. 2C is a diagram showing a display example of the content information extraction GUI according to the present embodiment;

FIG. 2D is a diagram showing a display example of the content information extraction GUI according to the present embodiment;

FIG. 2E is a diagram showing a display example of the content information extraction GUI according to the present embodiment;

FIG. 3 is an explanatory diagram illustrating a graph structure of the content distribution system according to the present embodiment;

FIG. 4A is a diagram showing a display example of a result reading stage of the content information extraction GUI in a case where a first track is a ring-shaped track;

FIG. 4B is a diagram showing a display example of a result reading stage of the content information extraction GUI in the case where the first track is the ring-shaped track;

FIG. 5A is a diagram showing a display example of the content information extraction GUI in a case where a shape of a region is an ellipse;

FIG. 5B is a diagram showing a display example of the content information extraction GUI in the case where the shape of the region is the ellipse;

FIG. 6A is a diagram showing a display example of the content information extraction GUI in a case where the shape of the region is a tetragon;

FIG. 6B is a diagram showing a display example of the content information extraction GUI in the case where the shape of the region is the tetragon;

FIG. 6C is a diagram showing a display example of the content information extraction GUI in the case where the shape of the region is the tetragon;

FIG. 7A is a diagram showing a display example of the content information extraction GUI in a case where content icons are placed in a tiled arrangement;

FIG. 7B is a diagram showing a display example of the content information extraction GUI in the case where content icons are placed in the tiled arrangement;

FIG. 7C is a diagram showing a display example of the content information extraction GUI in the case where content icons are placed in the tiled arrangement;

FIG. 8A is a diagram showing a display example of the content information extraction GUI in a case where content icons are placed in a line;

FIG. 8B is a diagram showing a display example of the content information extraction GUI in the case where content icons are placed in a line;

FIG. 8C is a diagram showing a display example of the content information extraction GUI in the case where content icons are placed in a line;

FIG. 9 is a flowchart showing procedures of an information processing method according to an embodiment of the present disclosure;

FIG. 10 is a diagram illustrating an overview of a content distribution system according to an embodiment of the present disclosure;

FIG. 11 is a diagram showing a display example of a content playback GUI according to the present embodiment;

FIG. 12 is a diagram showing a display example of the content playback GUI according to the present embodiment; and

FIG. 13 is a block diagram showing a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Configuration of content distribution system

2. Specific examples of content information extraction GUI
2-1. Display examples
2-2. Graph structure in content distribution system
2-3. Modified examples
   2-3-1. Modified example: ring-shaped first track
   2-3-2. Modified example: regions having other shapes
   2-3-3. Modified examples: content icons placed in tiled arrangement and in line

3. Procedures of information processing method

4. Examples of applications
4-1. Overview of content distribution system
4-2. Specific examples of content playback GUI

5. Hardware configuration

6. Supplement

### 1. CONFIGURATION OF CONTENT DISTRIBUTION SYSTEM

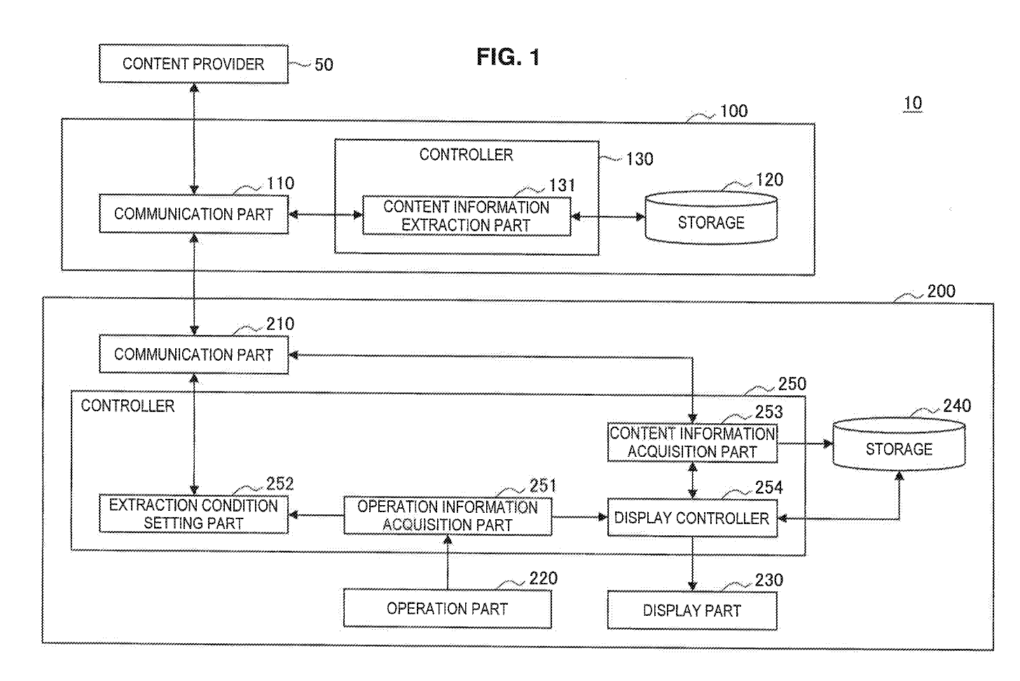

Referring to FIG. 1, there will be described a configuration example of a content distribution system according to an embodiment of the present disclosure. FIG. 1 is a functional block diagram showing a schematic configuration of functions of a content distribution system according to an embodiment of the present disclosure. Note that, hereinafter, the description will be given using as an example a case where video content is distributed in a content distribution system, the video content being a program such as telecasting or a movie.

Referring to FIG. 1, a content distribution system 10 according to an embodiment of the present disclosure includes a content provider 50, a server 100, and a client 200. The server 100 and the client 200 are each achieved by a hardware configuration of an information processing apparatus to be described later, and are connected to each other via various types of wired or wireless networks. Further, the server 100 and the content provider 50 are also connected to each other via various types of networks.

Note that, although FIG. 1 shows only one client 200 for simplicity of illustration, a plurality of clients 200 may also be each connected to the server 100 via a network. Further, the clients 200 may be connected to each other via a network. Further, for simplicity of illustration, FIG. 1 shows only functions related to various processes according to the present embodiment out of the functions of the server 100 and the client 200, and the other functions are omitted from the drawing. Although the description of the functions not shown in the drawing is omitted, the server 100 and the client 200 may further include structural elements for achieving various functions that a general known information processing apparatus has.

The content provider 50 is a content distribution server, for example, and manages and stores various types of content handled by the content distribution system 10. Here, the content provider 50 may further manage and store content information that is information related to content. The server 100 provides the client 200 with content managed by the content provider 50. The server 100 may also provide the client 200 with the content information acquired from the content provider 50 along with the content or independently of the content. Alternatively, the content information may also be managed by and stored in the server 100. The client 200 is, for example, an information processing apparatus such as a personal computer (PC), a tablet terminal, or a smartphone. A user may access the content and the content information provided by the server 100 via the client 200.

For example, the client 200 transmits an extraction condition used for extracting content information to the server 100. The server 100 extracts, based on the extraction condition, pieces of content information satisfying the extraction condition from pieces of content information that the content provider 50 has. The pieces of content information serving as extraction results are transmitted from the server 100 to the client 200, and are output in the client 200. The user can select content that the user wants to view based on the pieces of content information that have been output. When the user selects any one of the pieces of content information, the content corresponding to the selected content information is distributed to the client 200 from the content provider 50 via the server 100, and is viewed by the user.

Here, the content and the content information to be handled by the content distribution system 10 according to the present embodiment will be described. As described above, in the content distribution system 10, video content is distributed, for example. However, the present embodiment is not limited thereto, and the content to be distributed in the content distribution system 10 may be content of any form and type as long as the content can be processed by the client 200. For example, the form of the content may be text, music, an image, video, and the like. Further, for example, the type of the content may be a program such as telecasting or a movie, news of event reporting, a web site, and the like.

Further, the content information includes at least information that can identify the content. For example, the content information may include a thumbnail showing an overview of the content. However, it should be noted that the content information is not limited thereto, and the content information may include any information related to the content. For example, the content information may include information such as content updated date/time (e.g., date/time of registration of the content in the content provider 50), a title of the content, and a genre of the content. Further, for example, in the case where the content is a program such as telecasting or a movie, the content information may include information such as casts, playback time, a name, and the like of the program.

Functions of the server 100 and the client 200 will be described in detail. First, a configuration of functions of the server 100 will be described. The server 100 includes a communication part 110, a storage 120, and a controller 130.

The communication part 110 is a communication interface for connecting the server 100 to another external device in a state of being communicable with each other. The communication part 110 is achieved by using a communication device, for example. The server 100 can transmit/receive various types of information to/from the client 200 and the content provider 50 via the communication part 110. In the present embodiment, the communication part 110 receives, from the client 200, an extraction condition used for extracting pieces of content information. The communication part 110 receives, from the content provider 50, pieces of content information extracted based on the extraction condition. The communication part 110 transmits the extracted pieces of content information to the client 200. The communication part 110 receives, from the client 200, information indicating that any one of the pieces of pieces of content information has been selected by a user, and also transmits the information to the content provider 50. When content is distributed to the client 200, the communication part 110 receives the content transmitted by the content provider 50, and also transmits the content to the client 200.

The storage 120 is storage means for storing various types of information that are processed in the server 100. The storage 120 stores information generated in various processes performed by the controller 130, and also provides the controller 130 with desired information in response to a request from the controller 130. The storage 120 is configured from various types of storage devices, such as a magnetic storage device such as a hard disk drive (HDD), a semiconductor storage device, and an optical storage device. In the present embodiment, the storage 120 can at least temporarily store the extracted content information transmitted by the content provider 50. Further, when content is distributed to the client 200, the storage 120 may at least temporarily store the content transmitted by the content provider 50.

The controller 130 controls various processes performed in the server 100. The controller 130 includes a content information extraction part 131. Functions of the controller 130 including the above function are achieved by causing a processor of a central processing unit (CPU) to be operated in accordance with a program stored in memory.

The content information extraction part 131 executes extraction of content information based on an extraction condition used for extracting content information transmitted by the client 200. Specifically, the content information extraction part 131 receives an extraction condition used for extracting content information transmitted by the client 200 via the communication part 110. Then, the content information extraction part 131 accesses the content provider 50 via the communication part 110, and extracts, from pieces of content information managed by the content provider 50, content information matching the extraction condition. The server 100 transmits the extracted content information to the client 200 via the communication part 110. As described above, the server 100 may at least temporarily store the extracted content information in the storage 120.

Next, a configuration of functions of the client 200 will be described. The client 200 includes a communication part 210, an operation part 220, a display part 230, a storage 240, and a controller 250.

The communication part 210 is a communication interface for connecting the client 200 to another external device in a state of being communicable with each other. The client 200 can transmit/receive various types of information to/from the server 100 via the communication part 210. In the present embodiment, the communication part 210 transmits, to the server 100, an extraction condition used for extracting pieces of content information. The communication part 210 receives, from the server 100, pieces of content information extracted based on the extraction condition. The communication part 210 transmits, to the server 100, information indicating that any one of the pieces of content information has been selected by a user, and also receives content transmitted by the content provider 50 via the server 100.

The operation part 220 is an input interface for detecting various operation inputs performed by a user. The user can input various types of information and instructions to the client 200 via the operation part 220. The operation part 220 is configured from, for example, various input devices such as a mouse, a keyboard, and a touch panel. The operation part 220 provides operation information that is information about an operation input performed by the user to an operation information acquisition part 251 of the controller 250, which will be described later.

The display part 230 is an output interface for displaying various types of information on a display screen in diverse forms of text, an image, a chart, a graph, and the like, to thereby visually notify the user of the information. The display part 230 is configured from, for example, various types of display devices such as a liquid crystal display (LCD) and an organic electro-luminescence (EL) display. Note that, in the case where the operation part 220 includes a touch panel, the operation part 220 and the display part 230 are provided in an integrated manner. In the present embodiment, the display part 230 displays a display screen of a graphical user interface (GUI) (hereinafter, also referred to as “content information extraction GUI”), which will be described later, the GUI being used for inputting an extraction condition used for extracting pieces of content information and showing the pieces of content information serving as extraction results to the user, based on control performed by a display controller 254 of the controller 250. Further, the display part 230 may display, based on control performed by the display controller 254 again, a display screen of a GUI (hereinafter, also referred to as content playback GUI) for allowing the user to view content.

Here, in the present embodiment, on the content information extraction GUI, content icons corresponding to the pieces of content information are displayed. A content icon has a function as a headline showing an overview of content. For example, in the case where the content is a video, the content icon may include a thumbnail image displaying one scene of the video. Further, for example, in the case where the content is text, the content icon may be an image representing a character string that is a part of the text or a character string showing a title of the text.

The storage 240 is storage means for storing various types of information that are processed in the client 200. The storage 240 stores information generated in various processes performed by the controller 250, and also provides the controller 250 with desired information in response to a request from the controller 250. The storage 240 is configured from various types of storage devices, such as a magnetic storage device such as an HDD, a semiconductor storage device, and an optical storage device. In the present embodiment, the storage 240 may store the extracted content information transmitted by the server 100.

The controller 250 controls various processes performed in the client 200. The controller 250 includes the operation information acquisition part 251, an extraction condition setting part 252, a content information acquisition part 253, and the display controller 254. Functions of the controller 250 including the above functions are achieved by causing a processor of a CPU to be operated in accordance with a program stored in memory.

The operation information acquisition part 251 acquires operation information that is information about an operation input which is input by the user via the operation part 220. The operation information may include, for example, information showing an operation including moving various icons displayed as the GUI or selecting an icon from the various icons, or text information input by the user. Here, in the case where the operation part 220 includes a pointing device such as a mouse, the operation including moving the various icons displayed as the GUI or selecting an icon from the various icons may be executed via an operating piece such as a pointer (cursor) displayed on the GUI. Further, in the case where the operation part 220 includes a touch panel, an operation may be executed, the operation including moving an icon or selecting an icon performed directly with a touch by the user's finger or the like.

The extraction condition setting part 252 sets an extraction condition used for extracting content information based on operation information. In the present embodiment, for example, a display of the GUI controlled by the display controller 254 includes a search string entry field into which a character string for searching for content is entered. The operation information may include text information entered in the search string entry field. The extraction condition setting part 252 can set, as the extraction condition used for extracting content information, that the content information is related to the character string entered in the search string entry field. For example, in the case where the character string entered in the search string entry field is a name of a cast of a program such as telecasting or a movie, the extraction condition setting part 252 can set, as the extraction condition used for extracting content information, that the cast appears in the program.

Further, in the present embodiment, for example, a display of the GUI controlled by the display controller 254 includes icons representing various extraction conditions. The operation information may include information indicating that the icons are selected by the user. The extraction condition setting part 252 can set the extraction conditions corresponding to the selected icons as the extraction conditions used for extracting content information. Examples of the extraction conditions corresponding to the selected icons include: content is updated within a latest predetermined period (content is newly arrived content); content is accessed a predetermined number of times or more within a latest predetermined period; content is accessed by a specific user; and content is recommended.

The extraction condition setting part 252 transmits the set extraction condition to the server 100 via the communication part 210. In the server 100, the content information extraction part 131 extracts content information based on the extraction condition.

The content information acquisition part 253 acquires content information extracted based on the extraction condition. Specifically, the content information acquisition part 253 receives pieces of content information extracted by the content information extraction part 131 of the server 100 via the communication part 210. The content information acquisition part 253 provides the display controller 254 with the acquired pieces of content information. The content information acquisition part 253 may also provide the display controller 254 with information about the number of pieces of content information along with the acquired pieces of content information. Further, the content information acquisition part 253 may also store the acquired pieces of content information in the storage 240. Note that in the present embodiment, the content information acquisition part 253 may not necessarily acquire all of the extracted pieces of content information. The number of pieces of content information that the content information acquisition part 253 can acquire at one time may be appropriately set by the user.

The display controller 254 controls the display part 230, and causes the display part 230 to display various types of information. In the present embodiment, the display controller 254 causes the display part 230 to display various images and the like of the content information extraction GUI. Further, the display controller 254 may also cause the display part 230 to display various images and the like of the content playback GUI. In addition, the display controller 254 may further perform display control that is performed by a general information processing apparatus, the display control including moving a display of a pointer in the GUI based on an operation information acquired by the operation information acquisition part 251, for example.

Here, as described above, in the content information extraction GUI, content icons corresponding to pieces of content information are displayed. In the present embodiment, the display in the content information extraction GUI changes between at least two display stages (first display stage and second display stage), and the display controller 254 causes the content icons to be displayed in different modes between the first and second display stages. The content information extraction GUI in the first and second display stages will be described in detail in “2. Specific examples of content information extraction GUI” below. Note that the content icons may be included in advance, as pieces of image information, in the pieces of content information, or may be appropriately generated in any one of the server 100 and the client 200 based on various types of information included in the pieces of content information.

Heretofore, with reference to FIG. 1, the schematic configuration of functions of the content distribution system 10 according to the present embodiment has been described. Note that the configuration for achieving the content distribution system 10 according to the present embodiment is not limited to the example shown in FIG. 1, and the content distribution system 10 may have any configuration. For example, each process performed in the content distribution system 10, and each process performed in the controller 130 and the controller 250 in particular, may be performed in the server 100, or may be performed in the client 200. Further, the server 100 may not necessarily be achieved by a single information processing apparatus, and may be achieved by cooperation of a plurality of information processing apparatuses which are connected to each other via a network.

### 2. SPECIFIC EXAMPLES OF CONTENT INFORMATION EXTRACTION GUI

### 2-1. DISPLAY EXAMPLES

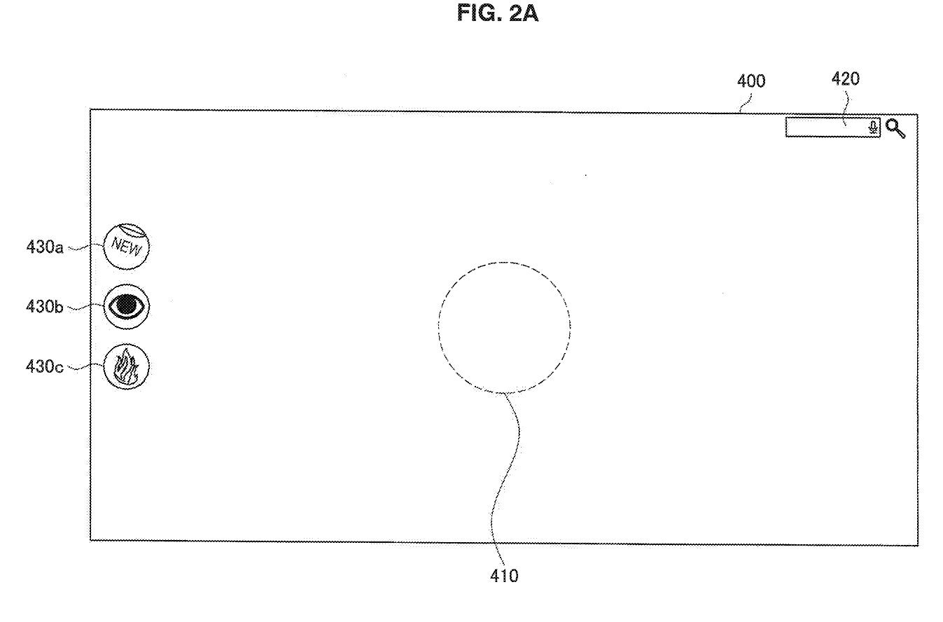

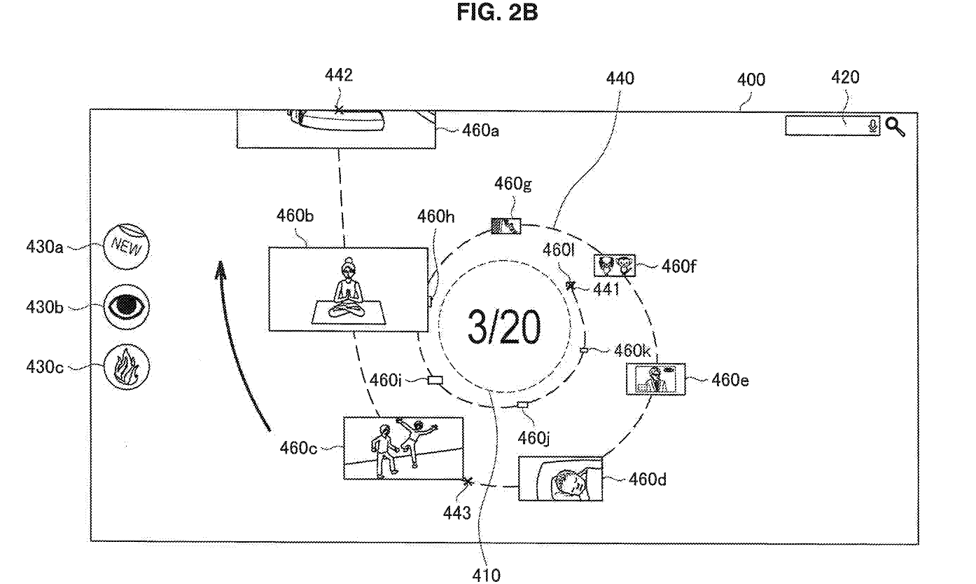

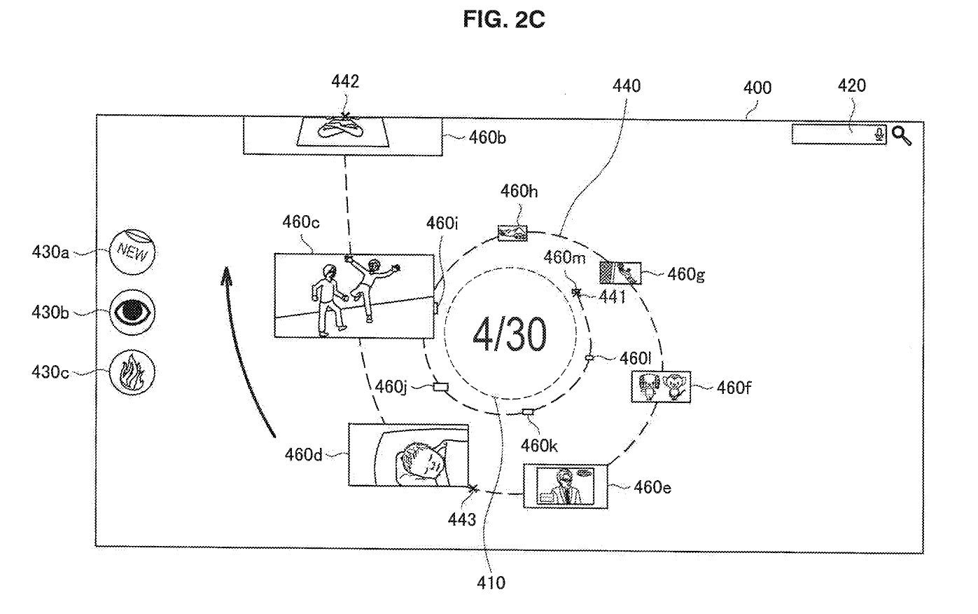

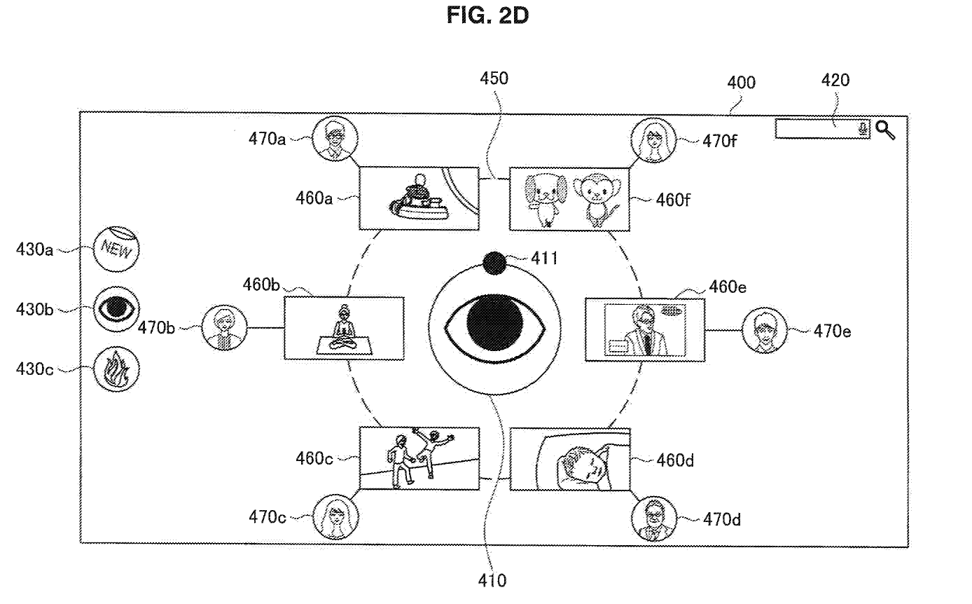

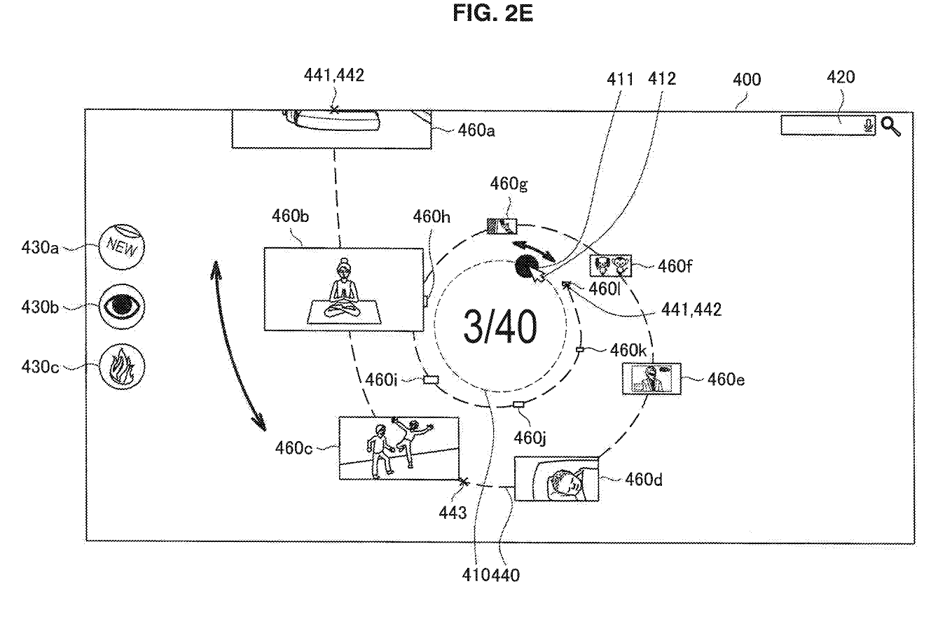

Next, with reference to FIGS. 2A to 2E, a display of a content information extraction GUI according to the present embodiment will be described, with concrete display examples. FIGS. 2A to 2E are each a diagram showing a display example of a content information extraction GUI according to the present embodiment. Note that the displays of content information extraction GUI's shown in FIGS. 2A to 2E and FIGS. 4A to 8C, which will be described later, may be displayed on the display part 230 of the client 200 by control performed by the display controller 254.

In the content information extraction GUI according to the present embodiment, first, the display controller 254 causes an initial screen to be displayed, to which an extraction condition used for extracting content information is input by a user. Next, when pieces of content information extracted based on the extraction condition are acquired by the client 200, the display controller 254 causes content icons corresponding to the pieces of content information serving as extraction results to be displayed on a track placed around a region. Here, in the present embodiment, in displaying the content icons serving as extraction results on the track, the display of the content icons may be changed into a plurality of stages.

Specifically, in a first display stage, the display controller 254 causes the content icons to be displayed sequentially on a first track in a manner that the content icons appear at a first point on the first track and disappear at a second point on the first track, the second point being different from the first point. The first display stage is a stage in which some of the content icons arranged in predetermined display order are displayed on the first track, and also, the content icons to be displayed are displayed in a manner that the content icons are sequentially replaced in accordance with the display order. In this case, the display controller 254 can acquire pieces of content information stored in the storage 240 and can sequentially display the content icons based on the acquired pieces of content information.

Further, in a second display stage, the display controller 254 causes a predetermined number of the content icons to be displayed on a second track. Note that the content icons to be displayed in the second display stage may be some of the content icons arranged in predetermined display order.

Further, the display of the content information extraction GUI may be further fractionalized into a plurality of stages during a series of processing procedures of acquiring the pieces of content information and displaying the content icons. For example, the display of the content information extraction GUI includes a result reading stage showing that extraction results are newly acquired, a result display stage in which a predetermined number of extraction results are displayed, and a display updating stage in which a display of extraction results is updated. The result reading stage and the display updating stage are stages included in the first display stage, and the result display stage is a stage included in the second display stage. As to the display of the content icons, the display controller 254 performs different display controls for the result reading stage, the result display stage, and the display updating stage.

Hereinafter, with reference to FIGS. 2A to 2E, there will be described sequentially the display controls on the content information extraction GUI in the initial screen, the result reading stage, the result display stage, and the display updating stage.

(Initial Screen)

FIG. 2A is a diagram showing a display example of an initial screen in a content information extraction GUI according to the present embodiment. When an application in the content distribution system 10 is activated in the client 200, the initial screen shown in FIG. 2A is displayed on the display part 230. Note that, before the initial screen is displayed, at the time of activating the application, a screen for performing user authentication into which user account information (user ID, password, and the like) is input may be displayed. Referring to FIG. 2A, in a display screen 400, a region 410 is provided at a substantially center of the initial screen. Here, the region 410 has a substantially circle shape in the examples shown in FIGS. 2A to 2E, and the region 410 is actually not displayed on the display screen 400. However, in FIGS. 2A to 2E, the region 410 is shown in a dashed line for the purpose of description. Note that the present embodiment is not limited thereto, and the shape showing the region 410 may be displayed on the display screen 400. Further, the shape of the region 410 is not limited to the circle, and may be any other shape. Note that the case of the region 410 being other shapes will be described in detail, in the following “2-3-2. Modified example: regions having other shapes”.

Inside the region 410, an icon showing an extraction condition used for extracting content information is displayed, for example. Referring to FIG. 2A, since extraction of content information has not been performed yet in the initial screen, nothing is displayed inside the region 410. However, the present embodiment is not limited thereto, and the extraction of content information may be performed automatically based on an extraction condition that has been set in advance when the application of the content distribution system 10 is activated. In the case where the extraction of content information is performed automatically when the application is activated, an icon showing the extraction condition may be shown inside the region 410 in the initial screen. Further, the extraction condition may be appropriately set by a user.

Further, referring to FIG. 2A, in the initial screen, a search string entry field 420 is displayed in a part of the region of the display screen 400. In the search string entry field 420, a search string to be an extraction condition used for extracting content information may be entered. Further, in the initial screen, extraction condition icons 430a to 430c are displayed in a part of the region of the display screen 400. The extraction condition icons 430a to 430c correspond to different extraction conditions, respectively. In the example shown in FIG. 2A, the extraction condition icon 430a shows an extraction condition that content information of newly arrived content is to be extracted, the extraction condition icon 430b shows an extraction condition that content information of content that is presently being viewed by another user is to be extracted, and the extraction condition icon 430c shows an extraction condition that content information of content with which another user has associated tag information within a latest predetermined period is to be extracted. The tag information will be described in detail in the following “4. Examples of applications”. Note that the present embodiment is not limited thereto, and the number and types of the extraction condition icons displayed on the display screen 400 may be appropriately set by the user. For example, the display screen 400 may have extraction condition icons corresponding to various other extraction conditions, such as: an extraction condition that content information of content which is being accessed a predetermined number of times or more within a latest predetermined period is to be extracted; and an extraction condition that content information of content which has recently been viewed by a user himself/herself is to be extracted.

In the initial screen shown in FIG. 2A, the user can perform an operation input for entering an extraction condition. The operation input may include, for example, entering a search string in the search string entry field 420 via the operation part 220, or selecting any one of the extraction condition icons 430a to 430c is selected by a user operation. Note that, in the present embodiment, the operation input of an extraction condition performed by the user may be executed by functions of the operation part 220, the operation information acquisition part 251, and the extraction condition setting part 252.

(Result Reading Stage)

When an extraction condition is input by the user in the initial screen shown in FIG. 2A and pieces of content information extracted based on the extraction condition are acquired by the content information acquisition part 253, the display of the content information extraction GUI changes into the result reading stage. Here, let us assume that the extraction condition icon 430b has been selected by the user as the extraction condition in the initial screen. Accordingly, the content information extraction part 131 of the server 100 extracts content information using as the extraction condition that content is presently being viewed by another user, and the content information acquisition part 253 acquires the extracted content information.

FIG. 2B and FIG. 2C each show an example of the display screen 400 in the result reading stage. Referring to FIG. 2B and FIG. 2C, in the result reading stage, a plurality of content icons 460a to 460l are displayed sequentially in a manner that the content icons 460a to 460l move on a first track 440 at predetermined intervals. In the examples shown in FIG. 2B and FIG. 2C, the first track 440 is a spiral track having the region 410 as the center thereof, but the spiral track is not displayed on the display screen 400. However, in FIG. 2B and FIG. 2C, the first track 440 is shown in a dashed line for the purpose of description. The content icons 460a to 460l are displayed sequentially in a manner that the content icons 460a to 460l move from an inner part to an outer part on the spiral track. In this way, in the result reading stage, a first point 441 at which the content icons 460a to 460l appear and a second point 442 at which the content icons 460a to 460l disappear may be located on the spiral track such that a distance between the first point 441 and the center is shorter than a distance between the second point 442 and the center. FIG. 2C shows a state in which a predetermined time period has elapsed from the state shown in FIG. 2B and the content icons 460a to 460l have been moved. In FIG. 2C, compared to the state shown in FIG. 2B, the content icon 460a has disappeared and a content icon 460m has newly appeared.

Note that, in the result reading stage, the content icons 460a to 460m may be displayed sequentially on the first track 440 in accordance with predetermined display order. The display order may be set based on a condition by the display controller 254 and other functions of the server 100 or the client 200, for example. The display order may be, for example, an updated order of pieces of content (order of new arrivals), and a descending order of the number of accesses to content within a latest predetermined period. In the case where an extraction condition used for extracting content information has a concept of order, the display order may be set based on the extraction condition.

Further, in the result reading stage, the content icons 460a to 460m may be displayed in a manner that sizes of the content icons 460a to 460m gradually increase as they move from an inner part to an outer part on the spiral track. By displaying the content icons 460a to 460m in a manner that the sizes of the content icons 460a to 460m gradually increase, the following visual effect is obtained: the content icons 460a to 460m move as if they are moving along a screw.

Further, although the examples shown in FIG. 2B and FIG. 2C show the case in which, in the result reading stage, the content icons 460a to 460m move clockwise on the first track, the present embodiment is not limited thereto. In the result reading stage, the content icons 460a to 460m are to be displayed sequentially in a manner that they move in a predetermined direction on the first track, and the direction in which they move may be any direction.

In the result reading stage, inside the region 410, information of the number of acquired pieces of content information may be displayed. In the examples shown in FIG. 2B and FIG. 2C, inside the region 410, there are displayed the total number of pieces of content information acquired by the content information acquisition part 253 and the number of content icons that have passed through a third point 443, the third point 443 being a predetermined point on the first track 440. Although the third point 443 is shown for convenience of the description in FIG. 2B and FIG. 2C, the third point 443 may not be actually displayed on the display screen 400. The number of content icons that have passed through the third point 443 on the first track 440 may be recognized by the display controller 254. Further, the display controller 254 may receive the number of acquired pieces of content information from the content information acquisition part 253. Accordingly, the display controller 254 can generate the display inside the region 410 based on those pieces of information. Here, the position of the third point 443 on the first track 440 may be set appropriately in a range that the position does not give an awkward feeling to a user observing movement of content icons. By appropriately setting the position of the third point 443, it can be considered that a content icon that has passed through the third point 443 on the first track 440 can be regarded as a content icon that has been displayed on the display screen 400 for a time period enough for which the user may have checked the content icon. Accordingly, the number of content icons that have passed through the third point 443 on the first track 440 is a rough estimate of the number of content icons checked by the user.

For example, in FIG. 2B, the character string “3/20” is displayed inside the region 410. Here, the denominator “20” represents the total number of acquired pieces of content information, the numerator “3” represents the number of content icons that have passed through the third point 443. In FIG. 2C, the number displayed inside the region 410 is increased along with the movement of the content icons, and the display is changed to “4/30”. Note that, as described above, in the present embodiment, the content information acquisition part 253 may not necessarily acquire all of the extracted pieces of content information. Accordingly, the total number of acquired pieces of content information displayed inside the region 410 may be increased up to the number of pieces of content information that the content information acquisition part 253 can acquire at one time, and may not be increased to be more than that. For example, in the case where the content information acquisition part 253 acquires content information again, the display of content icons in the result reading stage is performed again and also the total number of acquired pieces of content information is increased by the number of newly acquired pieces of content information. Note that the display inside the region 410 in the result reading stage is not limited thereto, and other information such as an icon showing an extraction condition may be displayed inside the region 410.

In the present embodiment, a condition for finishing the display of the result reading stage may be appropriately net by the user, for example. For example, content icons move on the first track 440, and, with the display of all or a predetermined number of content icons corresponding to the acquired pieces of content information, the result reading stage may be finished. Further, the time period for which the display of the result reading stage is performed may be appropriately set by the user, and the result reading stage may be finished when the set time period has elapsed. In this way, in the present embodiment, the time period for which the display of the result reading stage is performed may not necessarily correspond to the time period for which the content information acquisition part 253 actually acquires the pieces of content information. For example, in the case where an amount of information of the pieces of extracted content information is small, the acquisition of the pieces of content information performed by the content information acquisition part 253 may be executed in an extremely short time period. In that case, if only the time period for which the content information acquisition part 253 actually acquires the pieces of content information is set as the time period of the result reading stage, the display of the result reading stage may be finished in an extremely short time period, and there may occur a situation where the content icons are not recognized by the user. Accordingly, in the present embodiment, the time period of the result reading stage may be appropriately set to a predetermined time period for which the moving content icons can be recognized by the user, regardless of the length of the time period for which the content information acquisition part 253 actually acquires the pieces of content information. Further, speed at which the content icons move in the result reading stage may also be appropriately set in accordance with viewability of the moving content icons shown to the user, for example.

As described above, in the result reading stage, content icons showing extraction results are displayed sequentially in a manner that the content icons move on the first track. Accordingly, the user observes the display of the display screen 400 in the result reading stage, and thereby being able to take a general view of pieces of content information serving as extraction results.

(Result Display Stage)

When the result reading stage is finished, the display of the content information extraction GUI is changed into the result display stage. FIG. 2D shows an example of the display screen 400 in the result display stage.

Referring to FIG. 2D, in the result display stage, content icons 460a to 460f are displayed on a second track 450 at predetermined intervals. In the example shown in FIG. 2D, the second track 450 is a ring-shaped track placed around the region 410, and six content icons 460a to 460f are displayed on the ring-shaped track. The second track 450 shown in the example shown in FIG. 2D is actually not displayed on the display screen 400. However, in FIG. 2D, the second track 450 is shown in a dashed line for the purpose of description. Note that, in the result display stage, content icons selected from content icons each having higher priority in display order may be arranged on the second track 450 in accordance with the display order. In the example shown in FIG. 2D, the content icon 460a has the highest priority in the display order, for example, and in accordance with the display order, the content icon 460b, the content icon 460c, the content icon 460d, the content icon 460e, and the content icon 460f are arranged. Note that the display order of the content icons 460a to 460f in the result display stage may be the same as the display order of the content icons 460a to 460m in the result reading stage.

Further, in the result display stage, an icon showing an extraction condition used for extracting content information may be displayed inside the region 410. In the example shown in FIG. 2D, an icon that is the same as the extraction condition icon 430b is displayed in the region 410.

Referring to FIG. 2D, in the result display stage, user icons 470a to 470f each showing a user are further displayed around the content icons 460a to 460f. The user icons 470a to 470f are icons showing other users each associated with content. In this way, in the content distribution system 10 according to the present embodiment, a graph structure may be formed between pieces of content and the users based on an association therebetween, and a part of or all of the graph structure may be displayed in the result display stage. In the example shown in FIG. 2D, the fact that the pieces of content and the users are associated is expressed by displaying links between the content icons 460a to 460f and the user icons 470a to 470f. The graph structure in the content distribution system 10 will be described in detail in the following “2-2. Graph structure in content distribution system”.

In the result display stage, when any one of the content icons 460a to 460f and the user icons 470a to 470f is selected by an operation of a user, a predetermined operation may be performed. For example, in the case where any one of the content icons 460a to 460f is selected, a display screen of a content playback GUI may be displayed and content corresponding to the selected content icon may be played back. Further, for example, in the case where any one of the user icons 470a to 470f is selected, the fact of being associated with the user is used as an extraction condition and content information is extracted again, and the display control on the result reading stage and the result display stage may be performed again. In this way, the user icons 470a to 470f may also be each served as an extraction condition icon showing an extraction condition. In the case where any one of the user icons 470a to 470f is selected and content information is extracted again, the selected user icon may be displayed, as an icon showing the extraction condition, inside the region 410 in the result display stage.

In this way, in the result display stage, the user icons 470a to 470f are displayed along with the content icons 460a to 460f, and with the selection of any one of the user icons 470a to 470f, content information associated with the user may be extracted. The user can further select another content icon and/or user icon based on an extraction result of the content information associated with the other user who has been selected. In this way, in the present embodiment, a part of or all of the graph structure is displayed on the display screen 400 in the result display stage, and thus, exploration of pieces of content using the graph structure can be easily performed by the user.

Note that, although the user icons 470a to 470f are displayed as a part of the graph structure in the example shown in FIG. 2D, the present embodiment is not limited thereto. In the case where the pieces of content represented by the content icons 460a to 460f and/or the users represented by the user icons 470a to 470f are associated with other information, an icon representing the other information may further be displayed in association with the content icons 460a to 460f and/or the user icons 470a to 470f. Further, in the example shown in FIG. 2D, the user icons 470a to 470f are displayed in association with the content icons 460a to 460f, respectively, but the present embodiment is not limited thereto. In the present embodiment, a plurality of users may be associated with one piece of content in the graph structure, and reflecting this, a plurality of user icons may be displayed in association with one content icon in the result display stage.

(Display Updating Stage)

When a user performs a predetermined operation input for updating the display of extraction results in the result display stage, the display of the content information extraction GUI is changed into the display updating stage in which the display of extraction results is updated. FIG. 2E shows an example of the display screen 400 in the display updating stage.

Referring to FIG. 2E, in the display updating stage, display control processing that is similar to the display control processing in the result reading stage is performed. That is, in the display updating stage, a plurality of content icons 460a to 460l are displayed sequentially in a manner that the content icons 460a to 460l move on the first track 440 at predetermined intervals. However, in the display updating stage, the content icons 460a to 460l are moved in accordance with the operation input performed by the user for updating the display of extraction results. Note that, since the display control on content icons in the display updating stage is the same as the display control in the result reading stage apart from the fact that the content icons are moved in accordance with the operation input performed by the user, the description on the repeated matters will be omitted.

The operation input for updating the display of extraction results is, for example, an operation of moving an operation icon 411 displayed on the perimeter of the region 410 via a pointer 412, which is an operating piece. The shape of the region 410 is a circle, and this makes it possible to smoothly perform the operation of moving the operation icon 411 on the perimeter of the region 410. Further, the content icons 460a to 460l may be displayed in a manner that the content icons 460a to 460l move on the first track 440 in accordance with the movement distance and the movement direction of the operation icon 411 on the perimeter. For example, when the user moves the operation icon 411 clockwise on the perimeter of the region 410, the content icons 460a to 460l are also displayed in a manner that they move clockwise on the first track 440, and when the user moves the operation icon 411 anticlockwise on the perimeter of the region 410, the content icons 460a to 460l are also displayed in a manner that they move anticlockwise on the first track 440. Note that, in the present embodiment, the operation icon 411 may not be displayed, and the operation input for updating the display of extraction results may also be an operation of moving an operating piece such as the pointer 412 or an operating object such as a finger along the perimeter of the region 410. Further, the operation input for updating the display of extraction results is not limited thereto, and may be any other operation input to the content information extraction GUI.

In the example shown in FIG. 2E, in the same manner as in the result reading stage, the first track 440 is a spiral track having the region 410 as the center thereof. Accordingly, in accordance with the direction in which the user moves the operation icon 411 on the perimeter of the region 410, the content icons 460a to 460l are displayed in a manner that they move on the spiral track from the inner part toward the outer part or from the outer part toward the inner part. In this way, in the case where the first track 440 is a spiral track in the result reading stage, the first point 441 at which the content icons 460a to 460l appear may be set at one of the inner part and the outer part of the spiral track, and the second point 442 at which the content icons 460a to 460l disappear may be set at the other one of the inner part and the outer part of the spiral track.

Further, also in the display updating stage, in the same manner as in the result reading stage, information of the number of pieces of content information and/or content icons may be displayed inside the region 410. However, as described above, in the display updating stage, the content icons may be moved in both directions on the first track 440. Accordingly, the number of content icons having passed through the third point 443 on the first track 440, which may be displayed inside the region 410 in the display updating stage, may be the number of content icons that have passed through the third point 443 in a predetermined direction. For example, the number of content icons that have passed through the third point 443 of the first track 440 in the clockwise direction may be recognized by the display controller 254, and the number may be displayed inside the region 410. In the example shown in FIG. 2E, the character string “3/40” is displayed inside the region 410. The denominator “40” represents the total number of acquired pieces of content information, and the numerator “3” represents the number of content icons that have passed through the third point 443 on the first track 440 in the clockwise direction.

In the display updating stage, in the case where the operation input for updating the display of extraction results performed by the user is interrupted, the display of the content information extraction GUI returns to the result display stage. In that case, the result display stage may be displayed in the state that the movement of content icons in the display updating stage is reflected. Specifically, content icons, which are displayed on the display screen 400 at the moment of the operation input performed by the user is interrupted in the display updating stage, may be displayed on the second track 450 in the state in which the display positions thereof are reflected in the result display stage.

Here, in the display updating stage, if the updating of the display of content icons is continued, it ends up displaying all content icons corresponding to acquired pieces of content information on the first track 440. However, as described above, in the present embodiment, the content information acquisition part 253 may not necessarily acquire all of the extracted pieces of content information. Accordingly, even if all the acquired content icons are displayed on the first track 440, it does not mean that the content icons corresponding to all the extracted pieces of content information are checked by the user. Therefore, in the case where the user wants to check other pieces of content information, it is necessary that the content information acquisition part 253 acquire pieces of content information which have not been acquired yet.

Accordingly, in the present embodiment, in the display updating stage, in the case where the display controller 254 causes a predetermined number of content icons to be displayed in a manner that the content icons pass through the third point 443 on the first track 440 in a predetermined direction, the content information acquisition part 253 may acquire pieces of content information which have not been acquired yet. Further, the number of content icons which have passed through the third point 443, the number being a reference for the content information acquisition part 253 to acquire pieces of content information which have not been acquired yet, is set to a number smaller than the number of pieces of content information that the content information acquisition part 253 can acquire at one time. For example, let us assume that the number of pieces of content information that the content information acquisition part 253 can acquire at one time is 40. In the display updating stage, content icons move on the first track 440 in accordance with an operation input performed by the user, and in the case where less than 40 (for example, 30) content icons have passed through the third point 443 on the first track 440 in a predetermined direction, the content information acquisition part 253 may automatically acquire the pieces of content information which have not been acquired yet. Further, in the case where the total number of acquired pieces of content information is displayed in the region 410, the number of newly acquired pieces of content information may be reflected on a real-time basis on the display inside the region 410. For example, if the number of pieces of content information additionally acquired by the content information acquisition part 253 is 40, the display inside the region 410 showing the total number of the acquired pieces of content information is changed into “80”. In this way, before all the content icons corresponding to the acquired pieces of content information are displayed, the content information acquisition part 253 automatically acquires the pieces of content information which have not been acquired yet, and thus, further acquisition of pieces of content information is performed while the user is checking the content icons. Accordingly, it is not necessary that the user wait for reaquisition of pieces of content information, and the user can smoothly check the extraction results.

Heretofore, with reference to FIGS. 2A to 2E, the display control on the content information extraction GUI according to the present embodiment has been described specifically showing display examples. Here, in general existing display control, pieces of information are extracted from a plurality of pieces of information based on an extraction condition, and in the case where the extraction results thereof are to be shown to a user, only a result display screen in which the extraction results are displayed in a list is shown to the user, for example. Accordingly, in the case where the extraction results do not fit into one screen, it was necessary that the user perform an additional operation input such as scrolling of the display of the screen for checking the extraction results. In contrast, as described above, in the present embodiment, content icons serving as extraction results are displayed sequentially on the first track in the result reading stage. Accordingly, the user observes the display of the display screen 400 in the result reading stage, and thereby being able to take a general view of the extraction results without performing any additional operation input. Therefore, the viewability of the extraction results shown to the user is enhanced.

Further, in the present embodiment, also in the display updating stage, content icons serving as extraction results are displayed sequentially in a manner that the content icons move on the first track. Accordingly, since the user can cause the extraction results to be displayed sequentially and can check the contents of the extraction results, the user can easily find a desired extraction result. In this way, in the present embodiment, the display of the content information extraction GUI includes the first display stage, and therefore, the viewability of the extraction results shown to the user is enhanced.

Note that, in the examples shown in FIGS. 2B to 2E, the first track 440 is a spiral track having the region 410 as the center and the second track 450 is a ring-shaped track having the region 410 as the center, but the present embodiment is not limited thereto. The first track 440 and the second track 450 may each have another shape as long as the track is placed around the region 410. Further, although the first track 440 and the second track 450 shown in the examples shown in FIGS. 2B to 2E are actually not displayed on the display screen 400, the present embodiment is not limited thereto. The line showing the first track 440 and the line showing the second track 450 may be displayed on the display screen 400.

Further, in the present embodiment, a method of displaying a content icon at the time at which the content icon appears or disappears in the first display stage is not limited to a particular method. For example, when a content icon appears, the content icon may be displayed in a manner that the content icon enters into a screen while moving, or in a manner that the content icon is suddenly displayed at the first point. Further, the content icon may be displayed in a manner that the size of the content icon gradually increases, for example, so that the fact that the content icon is appearing is emphasized. Further, for example, when a content icon disappears, the content icon may be displayed in a manner that the content icon exits out of the screen while moving, or in a manner that the content icon is suddenly vanished. Further, the content icon may be displayed in a manner that the content icon disappears while the size of the content icon is gradually decreasing, or in a manner that the content icon disappears while the content icon gradually gets paler, for example, so that the fact that the content icon is disappearing is emphasized.

### 2-2. GRAPH STRUCTURE IN CONTENT DISTRIBUTION SYSTEM

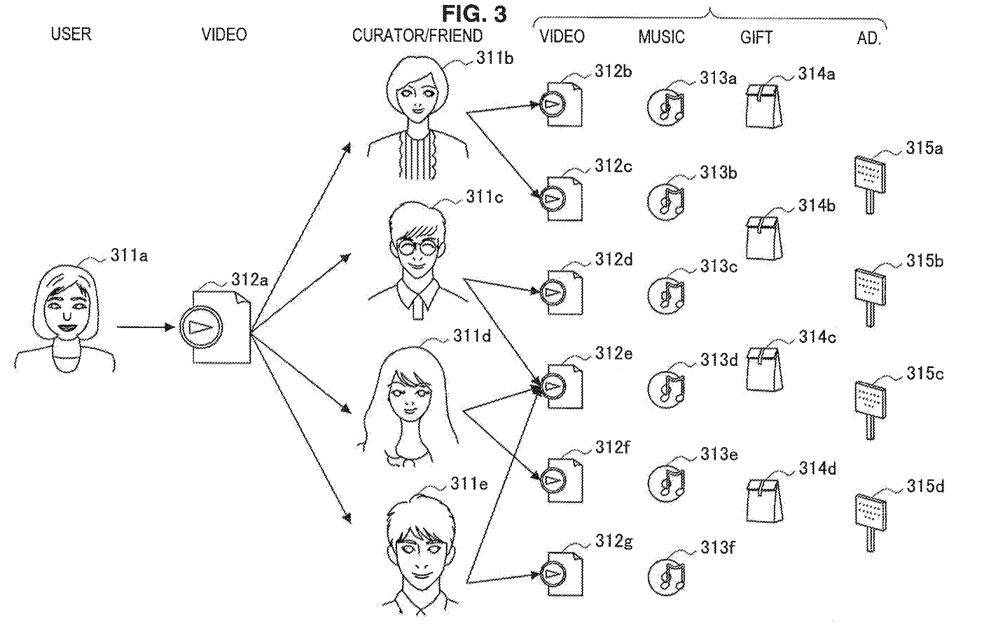

As described above, in the content distribution system 10, a graph structure may be formed between pieces of content and users based on associations between the pieces of content and the users, and an exploration of pieces of content using the graph structure may be performed by a user. With reference to FIG. 3, a graph structure of the content distribution system 10 according to the present embodiment will be described. FIG. 3 is an explanatory diagram illustrating a graph structure of the content distribution system 10 according to the present embodiment.

Referring to FIG. 3, there are shown users 311a to 311e of the content distribution system 10, and pieces of video content 312a to 312g to be distributed to a client 200 in the content distribution system 10. Arrows shown between the users 311a to 311e and the pieces of video content 312a to 312g each show that there is an association between any of the users 311a to 311e and any of the pieces of video content 312a to 312g linked with an arrow. The association represents, for example, that the users 311a to 311e viewed the pieces of video content 312a to 312g in the past, that the users 311a to 311e register the pieces of video content 312a to 312g in their respective “Favorites” lists, and that the users 311a to 311e recommend the pieces of video content 312a to 312g to other users.

For example, let us assume that the user 311a views the video content 312a. The video content 312a is associated with the users 311b to 311e, and the user 311a who has viewed the video content 312a is provided with pieces of information about the users 311b to 311e. In addition, for example, the user 311b is associated with the pieces of video content 312b and 312c. Accordingly, by accessing the user 311b, it becomes also possible for the user 311a to access the pieces of video content 312b and 312c each associated with the user 311b. Note that the users 311b to 311e may each be a friend who is registered as a friend of the user 311a, or may each be a curator who is a user taking a role of sorting out pieces of content.

In this way, the content distribution system 10 has the graph structure in which users and pieces of content are linked based on predetermined associations. A user of the content distribution system 10 can explore sequentially pieces of content and users by using the graph structure. Content associated with the user can be regarded as content which the user is interested in, and therefore, the content accessed by the exploration using the graph structure may be content which the user who performed the exploration is interested in. In this way, by performing the exploration using the graph structure, it becomes possible for the user to access the content which the user is interested in.

Further, in the content distribution system 10, other information may be associated with the pieces of video content 312a to 312g and the users 311a to 311e. In FIG. 3, as examples of the other information, there are shown pieces of music information 313a to 313f, pieces of gift information 314a to 314d, and pieces of advertisement information 315a to 315d. For example, the pieces of music information 313a to 313f may be pieces of information about music pieces included in the pieces of video content 312a to 312a, or may be pieces of information about music pieces which were listened to by the users 311a to 311e in the past. Further, the pieces of gift information 314a to 314d and the pieces of advertisement information 315a to 315d may be pieces of information about gifts and advertisements related to videos, which may be displayed on playback screens of the pieces of video content 312a to 312g, or may be pieces of information about gifts and advertisements which were purchased or viewed by the users 311a to 311e in the past, which may be displayed on playback screens of the pieces of video content 312a to 312g. In this way, in the content distribution system 10, the graph structure may be formed among the pieces of video content 312a to 312g, the users 311a to 311e, the pieces of music information 313a to 313f, the pieces of gift information 314a to 314d, and the pieces of advertisement information 315a to 315d. The user may also access diverse pieces of information by exploring the pieces of video content 312a to 312g. The graph structure is formed among the diverse pieces of information and the pieces of content, and thus, the range of information and content that the user may access in the exploration is further widened.

Further, in the content distribution system 10, tag information can be associated with the content. The tag information includes, for example, text, a link to a web page, and a link to other content. The tag information is associated with any playback position of the content. Further, in the case where the content is video content, the tag information may be associated with a position inside the playback screen of the content. Those pieces of tag information may each be associated with content by the user himself/herself, or may each be associated with content by another user. In the present embodiment, it becomes possible for the user to further access another piece of content based on the tag information associated with the accessed content. The access to the content using such tag information may be regarded as an exploration of pieces of content using the tag information. Note that the way of associating tag information with content will be described in detail in the following “4. Examples of applications”.

### 2-3. MODIFIED EXAMPLES

Next, modified examples of display control on the content information extraction GUI according to the present embodiment will be described. In below, in the same manner as FIGS. 2A to 2E, the description of the modified examples will be given showing concrete display examples of the content information extraction GUI. However, for simplicity of illustration, a drawing such as a thumbnail displayed inside a content icon is omitted, and the content icon is shown as a tetragon frame. Further, a frame representing a content icon drawn with a dashed line means that a state of the content icon is immediately after having been appeared on the first track or immediately before disappearing from the first track. Further, numbers which show content icons and are attached inside or outside the frames represent display order of the content icons.

### 2-3-1. Modified Example: Ring-Shaped First Track

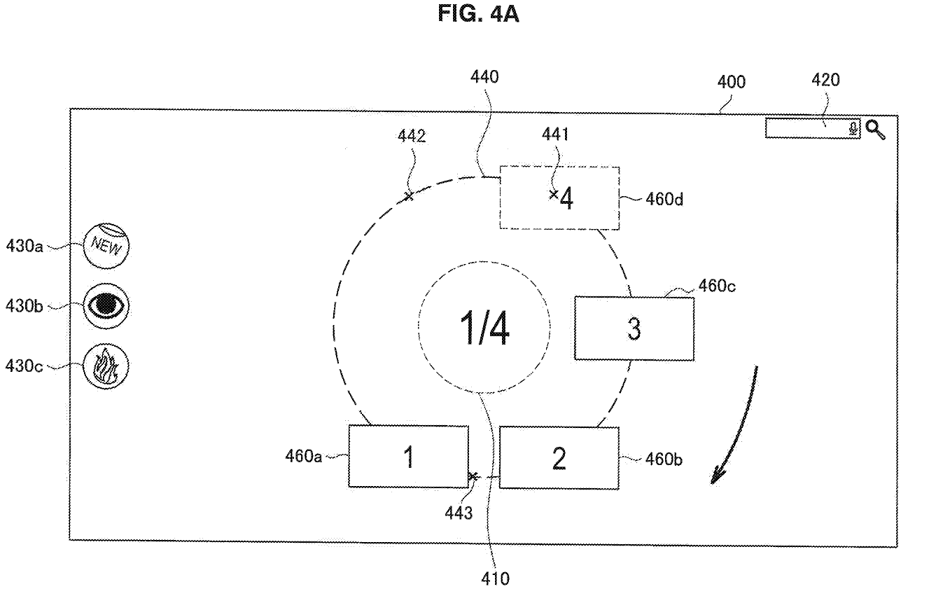

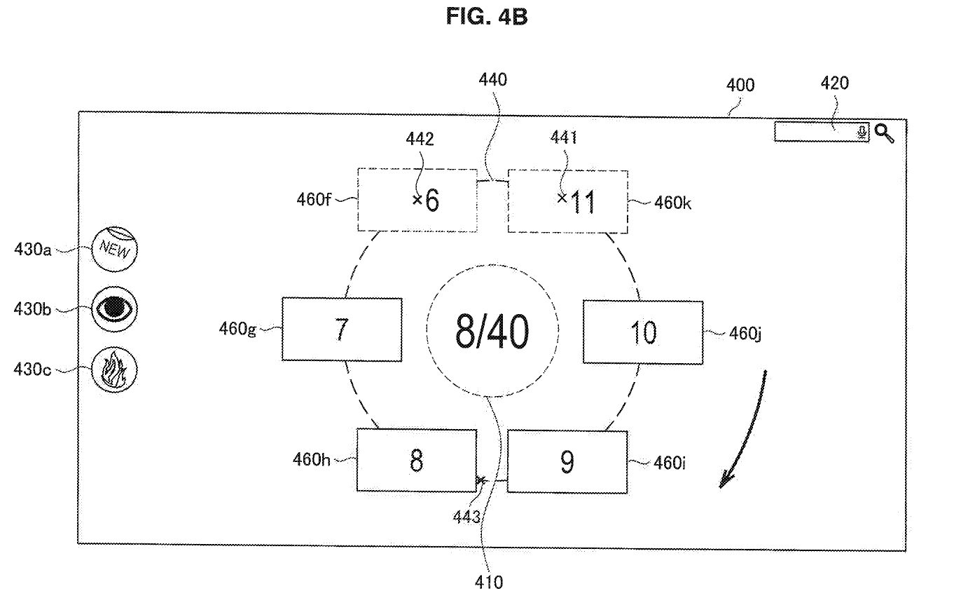

As described above, in the result reading stage and the display updating stage of the present embodiment, the first track may not be a spiral track, and may be a ring-shaped track, for example. With reference to FIG. 4A and FIG. 4B, there will be described a modified example in which the first track is a ring-shaped track in the content information extraction GUI. FIG. 4A and FIG. 4B are each a diagram showing a display example of the result reading stage of the content information extraction GUI in the case where the first track is a ring-shaped track. Note that, in the present modified example, the same display control may be performed as the display control described in the above “2-1. Display examples”, apart from the fact that the first track is a ring-shaped track. Accordingly, the description will be mainly given on the differences between the display control of the present modified example and the display control described in the above “2-1. Display examples”, and the description on the repeated matters will be omitted.

Referring to FIG. 4A and FIG. 4B, in the present modified example, content icons are displayed sequentially on the first track 440 which is a ring-shaped track. FIG. 4A shows a state where content icons 460a to 460d are displayed sequentially in a manner that they move clockwise on the first track 440, the content icons 460a to 460d corresponding to pieces of content information, which are first to fourth in terms of display order, out of acquired pieces of content information. Further, in the same manner as FIG. 2B and FIG. 2C, there are shown inside the region 410 total number of acquired pieces of content information and the number of content icons that have passed through the third point on the first track 440.

FIG. 4B shows a state in which a predetermined time period has elapsed from the state shown in FIG. 4A. The state shown in FIG. 4B represents the following: 40 pieces of content information are acquired; it is immediately after a content icon 460k, which is 11th in terms of display order, has appeared at the first point 441 on the first track 440; and it is immediately before a content icon 460f, which is sixth in terms of display order, disappears at the second point 442 on the first track 440.

In this way, in the present embodiment, the first track 440 may be a ring shape, and in the result reading stage, the content icons may be displayed sequentially in a manner that they move on the ring-shaped track. Further, in the display updating stage, the content icons may be displayed sequentially in a manner that they move on the ring-shaped track in accordance with an operation input for updating the display of extraction results performed by a user, as shown in FIG. 4B.

### 2-3-2. Modified Example: Regions Having Other Shapes

The region 410 has a substantially circle shape in the examples shown in FIGS. 2A to 2E, but in the present embodiment, the region 410 may have other shapes as described above. The description will be given specifically on a modified example in which the region 410 has other shape in the content information extraction GUI. Note that, in the present modified example, the same display control may be performed as the display control described in the above “2-1. Display examples”, apart from the fact that the shape of the region 410 is different. Accordingly, the description will be mainly given on the differences between the display control of the present modified example and the display control described in the above “2-1. Display examples”, and the description on the repeated matters will be omitted.

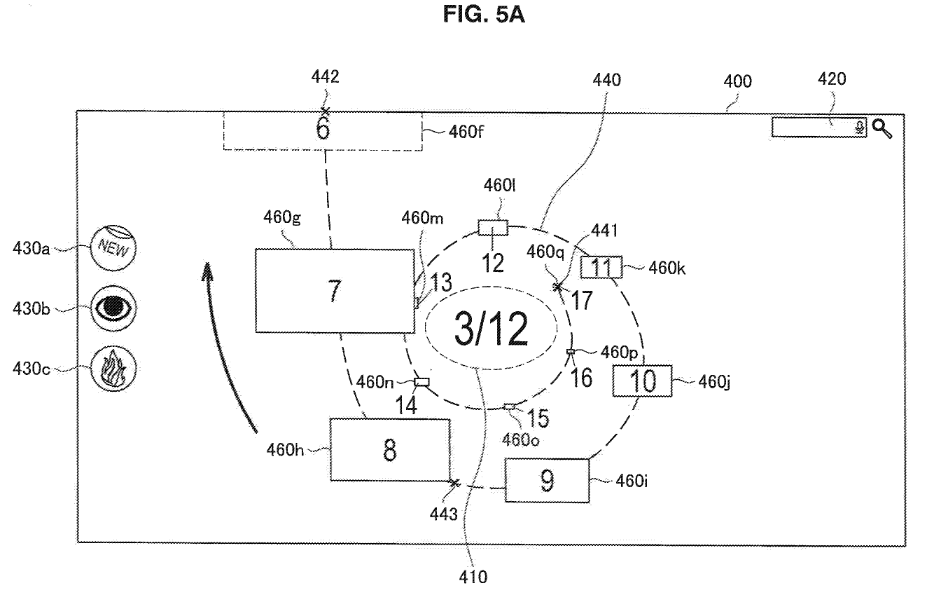

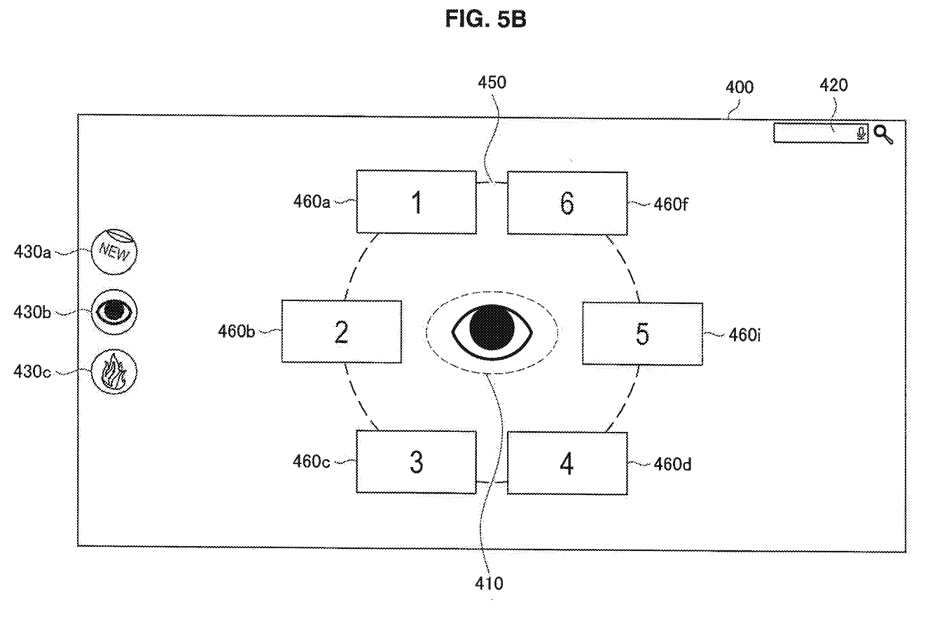

First, with reference to FIG. 5A and FIG. 5B, there will be given the description on display control processing in the case where the shape of the region 410 is an ellipse. FIG. 5A and FIG. 5B are each a diagram showing a display example of the content information extraction GUI in the case where the shape of the region 410 is an ellipse. FIG. 5A shows a display example in the result reading stage, and FIG. 5B shows a display example in the result display stage.

Referring to FIG. 5A, in the result reading stage, content icons 460f to 460q are displayed sequentially in a manner that they move clockwise on a spiral first track 440 having as the center thereof the ellipse region 410. Further, the content icons 460f to 460q are displayed in a manner that the sizes thereof gradually increase as the content icons 460f to 460q move from an inner part to an outer part on the spiral track. In this way, in the present modified example, in the result reading stage, the content icons 460f to 460q may be displayed in a manner that they move as if they are moving along a screw around the ellipse region 410 serving as the center.

Note that also in the display updating stage according to the present modified example, as shown in FIG. 5A, the content icons 460f to 460q may be displayed sequentially in a manner that they move on the first track 440. However, in the display updating stage, the content icons 460f to 460q may also be displayed sequentially in a manner that they move on the first track 440 in accordance with an operation input for updating the display of extraction results performed by a user, and the operation input may be an operation of moving an operation icon displayed on the perimeter of the region 410 on the perimeter. The shape of the region 410 is an ellipse, and this makes it possible to smoothly perform the operation of moving the operation icon on the perimeter of the region 410.

Referring to FIG. 5B, in the result display stage, content icons 460a to 460f are displayed on a ring-shaped second track 450 having as the center thereof the ellipse region 410. In this way, in the present modified example, in the result display stage, content icons 460a to 460f may be displayed on the ring-shaped track having as the center thereof the ellipse region 410.

Heretofore, with reference to FIG. 5A and FIG. 5B, the display control processing in the case where the shape of the region 410 is an ellipse has been described specifically. Note that, also in the present modified example, as described in the above “2-3-1. Modified example: ring-shaped first track”, the first track may be a ring-shaped track, and the content icons may be displayed sequentially in a manner that they move on the ring-shaped track in the result reading stage and the display updating stage.

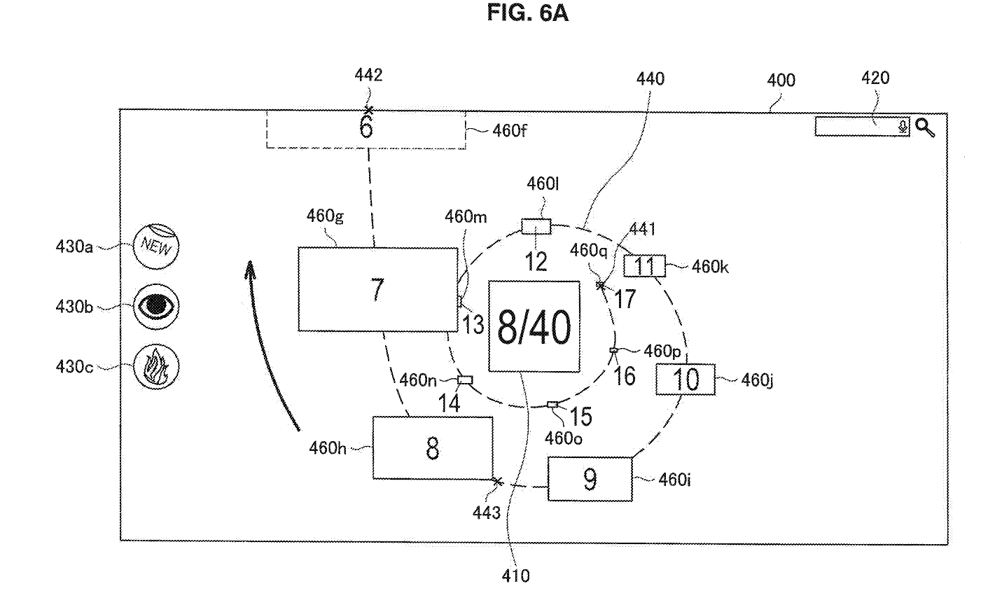

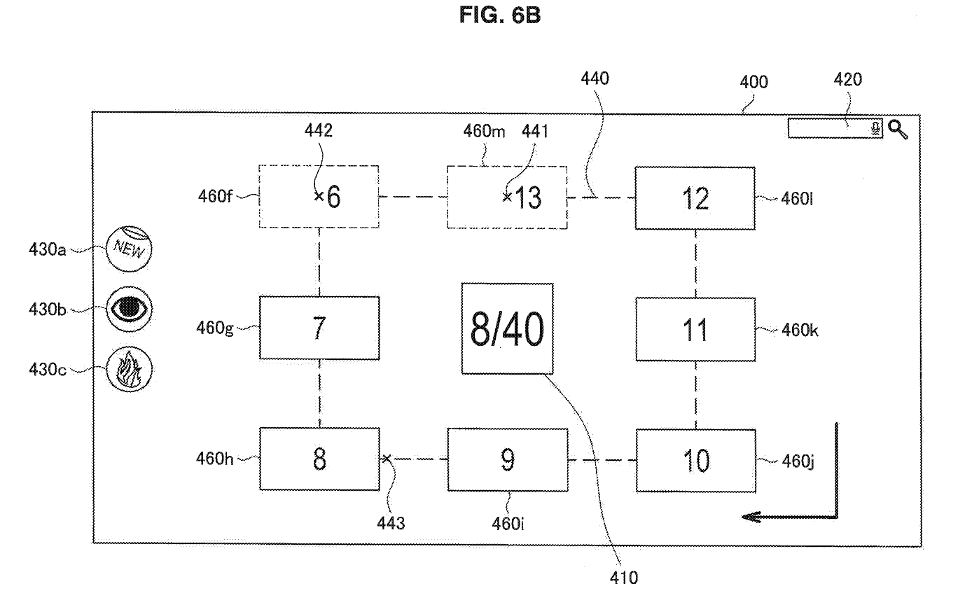

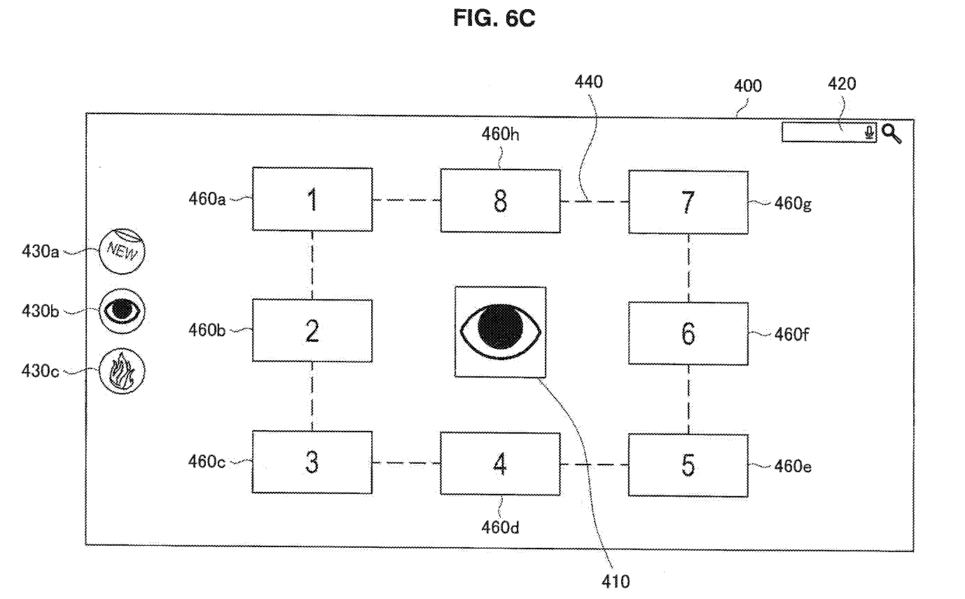

Next, with reference to FIGS. 6A to 6C, there will be given the description on display control processing in the case where the shape of the region 410 is a tetragon. FIGS. 6A to 6C are each a diagram showing a display example of the content information extraction GUI in the case where the shape of the region 410 is a tetragon. FIG. 6A shows a display example in the result reading stage. Further, FIG. 6B shows another display example in the result reading stage. Further, FIG. 6C shows a display example in the result display stage.

Referring to FIG. 6A, in the result reading stage, content icons 460f to 460q are displayed sequentially in a manner that they move clockwise on a spiral first track 440 having as the center thereof the tetragon region 410. Further, the content icons 460f to 460q are displayed in a manner that the sizes thereof gradually increase as the content icons 460f to 460q move from an inner part to an outer part on the spiral track. In this way, in the present modified example, in the result reading stage, the content icons 460f to 460q may be displayed sequentially in a manner that they move as if they are moving along a screw around the tetragon region 410 serving as the center.

FIG. 6B is a display example in the result reading stage, and shows another display example different from the display example shown in FIG. 6A. Referring to FIG. 6B, in the result reading stage, content icons 460f to 460m are displayed sequentially in a manner that they move clockwise on a ring-shaped first track 440 having as the center thereof the tetragon region 410. The display example shown in FIG. 6B corresponds to a case where the first track described with reference to FIG. 4A and FIG. 4B is a ring-shaped track. In this way, even in the modified example with the region 410 having a different shape, the first track may be a ring-shaped track, and the content icons may be displayed sequentially in a manner at they move on the ring-shaped track.

Note that also in the display updating stage according to the present modified example, as shown in FIG. 6A and FIG. 6B, the content icons 460f to 460q may be displayed sequentially in a manner that they move on the first track 440. However, in the display updating stage, the content icons 460f to 460q may also be displayed sequentially in a manner that they move in accordance with an operation input for updating extraction results performed by a user, and the operation input may be an operation of moving an operation icon displayed on the perimeter of the region 410 on the perimeter.

Referring to FIG. 6C, in the result display stage, content icons 460a to 460h are displayed on a ring-shaped second track 450 having as the center thereof the tetragon region 410. In this way, in the present modified example, in the result display stage, content icons 460a to 460h may be displayed on the ring-shaped track having as the center thereof the tetragon region 410.

Heretofore, with reference to FIG. 5A, FIG. 5B and FIGS. 6A to 6C, modified examples in which the region 410 has other shapes in the content information extraction GUI have been described specifically. Note that in the above “2-3-1. Modified example: ring-shaped first track” and the present modified example, in the case where the first track 440 has a ring shape, the display of color or the like of a content icon immediately before disappearing and/or a content icon immediately after having been appeared may be different from the display of color or the like of other content icons. Further, in the case where the first track 440 has a ring shape, the sizes of the content icons may be changed in accordance with display order. For example, content icons may be displayed in a manner that the sizes thereof gradually increase as the numbers representing the display order are relatively smaller among the content icons displayed in the display screen 400, that is, as the content icons approach the second point 442 from the first point 441 on the first track 440. Further, for example, content icons may be displayed in a manner that the sizes thereof gradually increase only in a predetermined block from the first point 441, and may be displayed in a manner that the content icons move in substantially the same size in a block other than the predetermined block. In this way, content icons are displayed so that the following information becomes visually clear for the user: that a content icon is immediately after having been appeared; that a content icon is immediately before disappearing; and/or display order of content icons. Accordingly, the user observing the display can understand more easily and in more detail the display stages of the content information extraction GUI, and thus, the user's viewability with respect to the extraction results is further enhanced.

### 2-3-3. Modified Examples: Content Icons Placed in Tiled Arrangement and in Line

Next, the description will be given on modified examples in which content icons are not displayed on a track placed around a region in the content information extraction GUI. Also in the present modified example, the display of the display screen 400 includes the result reading stage, the result display stage, and the display updating stage, but content icons are not displayed on a track placed around a region in each stage and are displayed in another mode. Note that, in the present modified example, the same display control may be performed as the display control described in the above “2-1. Display examples”, apart from the fact that the content icons are not displayed on a track placed around a region. Accordingly, the description will be mainly given on the differences between the display control of the present modified example and the display control described in the above “2-1. Display examples”, and the description on the repeated matters will be omitted.

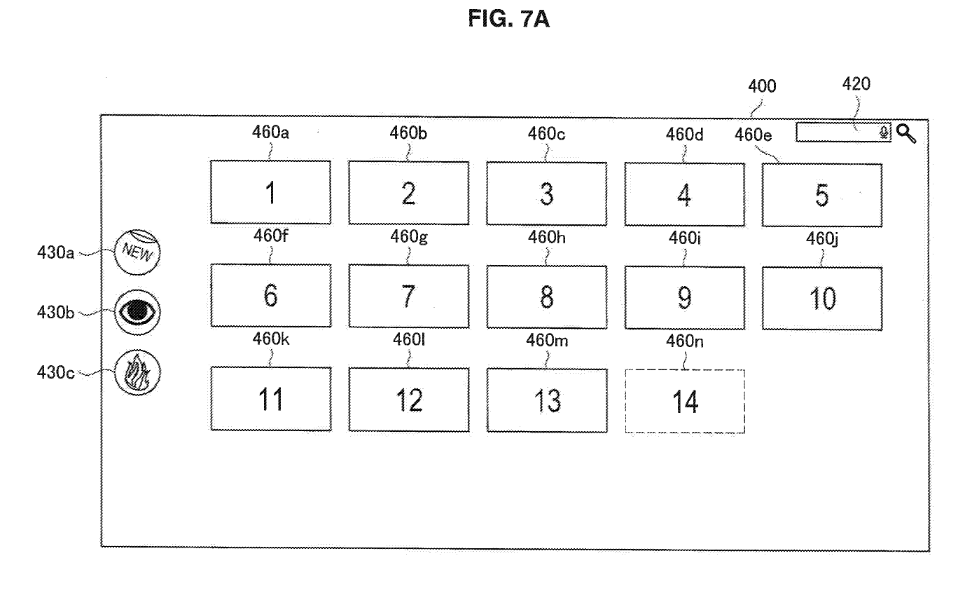

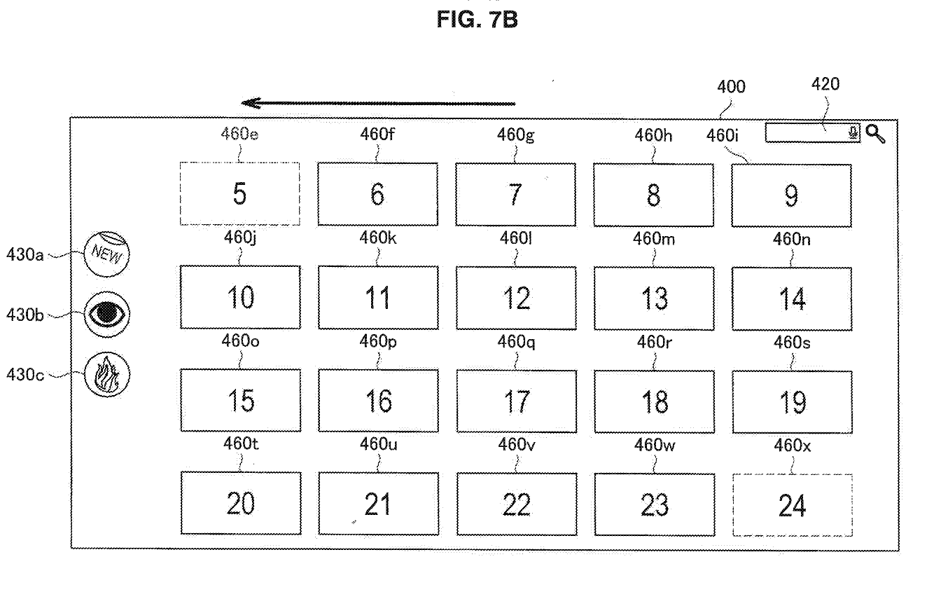

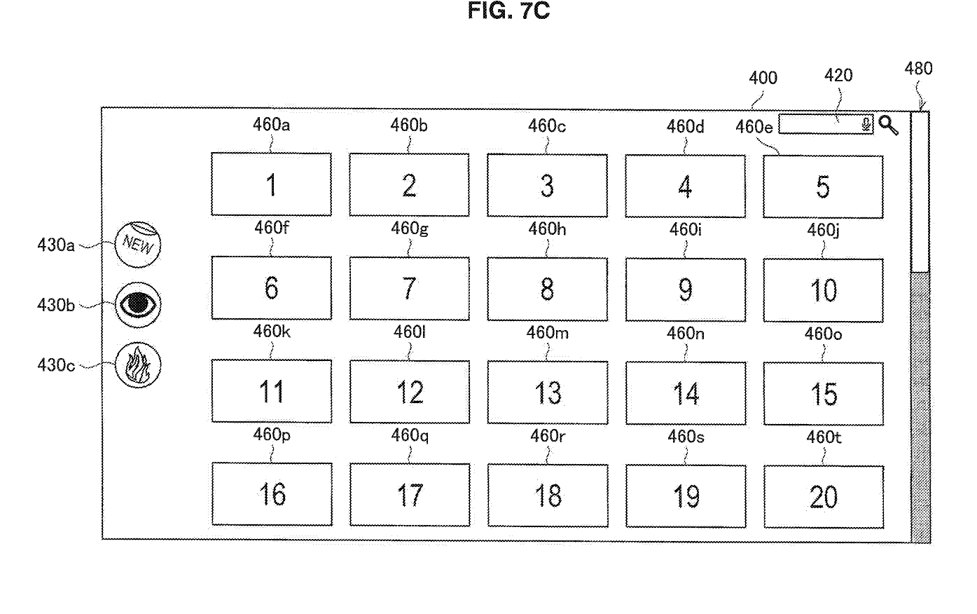

First, with reference to FIGS. 7A to 7C, there will be given the description on a modified example in which content icons are placed in a tiled arrangement. FIGS. 7A to 7C are each a diagram showing a display example of the content information extraction GUI in a case where content icons are placed in a tiled arrangement. FIG. 7A and FIG. 7B each show a display example in the result reading stage, and FIG. 7C shows a display example in the result display stage and the display updating stage.

Referring to FIG. 7A, in the present modified example, in the result reading stage, content icons are displayed sequentially in a manner that they are placed in a tiled arrangement in order from the top-left of the display screen 400. In the example shown in FIG. 7A, there are displayed content icons 460a to 460n corresponding to pieces of content information, which are first to 14th in terms of display order, out of acquired pieces of content information.

FIG. 7B shows a display example of the display screen 400 in a state in which a predetermined time period has elapsed from the state shown in FIG. 7A. As shown in FIG. 7B, in the present modified example, when a predetermined number of content icons are placed in a tiled arrangement, the content icons are displayed sequentially in a manner that they move from right to left within each row. In this case, a content icon located at the leftmost position in each row is displayed in a manner that the content icon moves to the rightmost position in the row immediately above. Further, the content icons are displayed in a manner that a content icon located at the leftmost position in the uppermost row disappears, and a content icon, which is next to be displayed in terms of display order, appears at the rightmost position in the lowermost row. In the example shown in FIG. 7B, a state is shown where the content icon 460e, which is fifth in terms of display order, disappears, and the content icon 460x, which is 24th in terms of display order, appears. Note that, in the present modified example, content icons may be displayed sequentially in a manner that they are placed in a tiled arrangement, and the way of arranging the content icons, the positions at which the content icons appear and disappear, and the direction in which the content icons move are not limited to the above example.

Referring to FIG. 7C, in the result display stage, content icons which are all of or a part of extraction results are placed in a tiled arrangement in accordance with display order. As shown in FIG. 7C, although only content icons 460a to 460t are displayed on one screen of the display screen 400, the content icons 460a to 460t may further be followed by other content icons which do not fit into the display screen 400 in the downward direction of the screen. A scroll bar 480 may be displayed in the display screen 400, and by operating the scroll bar, the display of the display screen 400 is scrolled. In the display updating stage, the user scrolls the display of the display screen 400, and thus updating the display of extraction results and can check other content icons.

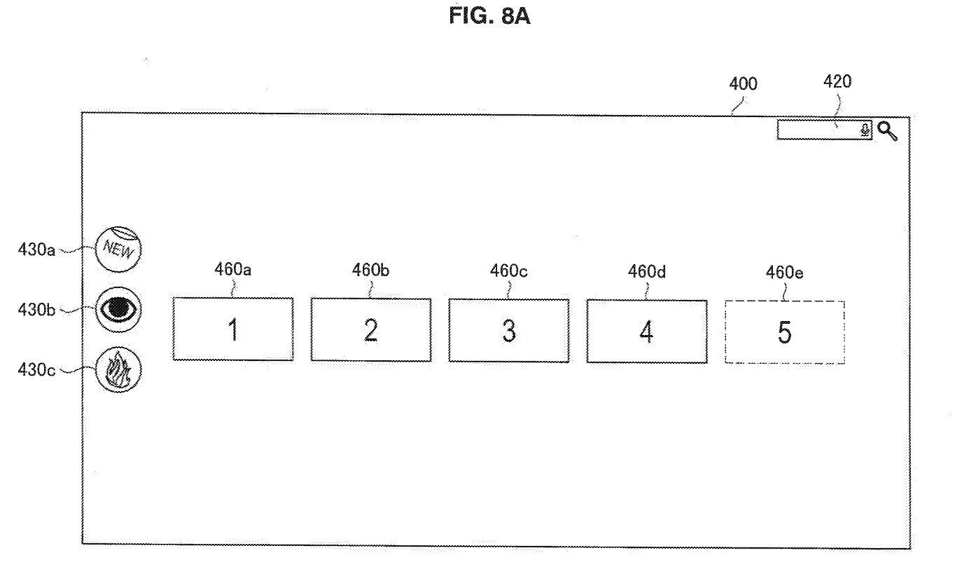

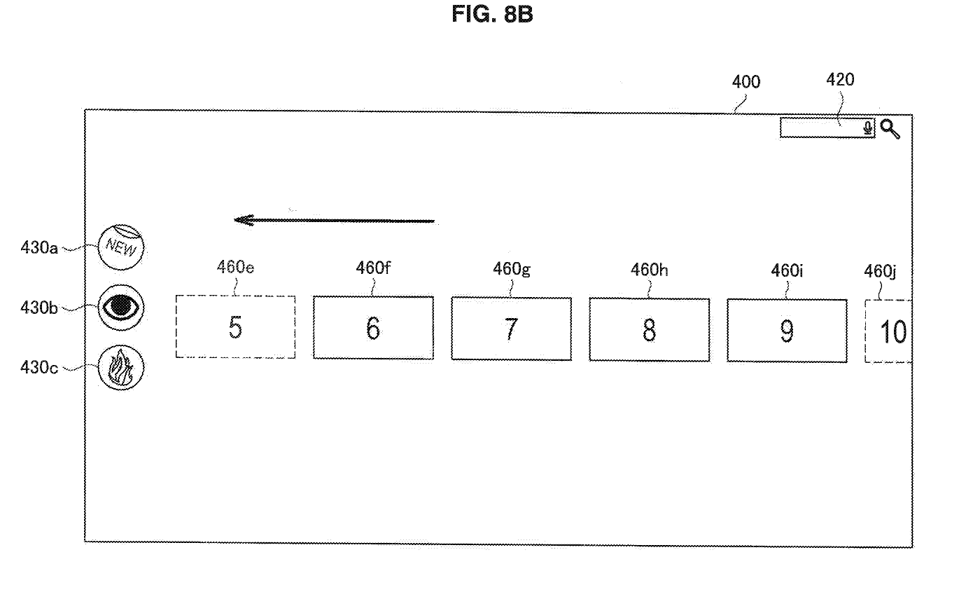

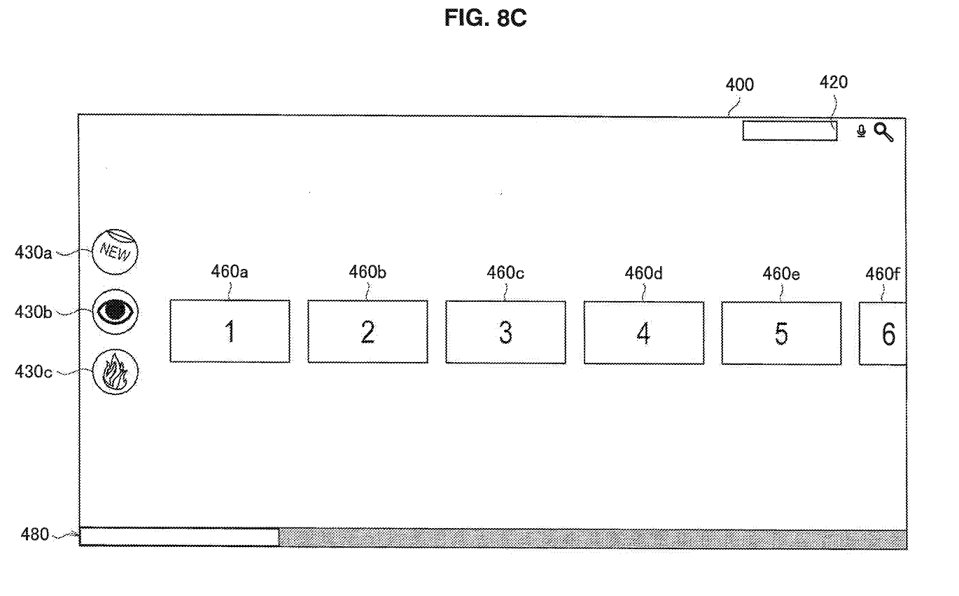

Next, with reference to FIGS. 8A to 8C, there will be given the description on a modified example in which content icons are placed in a line. FIGS. 8A to 8C are each a display example of the content information extraction GUI in a case where content icons are placed in a line. FIG. 8A and FIG. 8B each show a display example in the result reading stage, and FIG. 8C shows a display example in the result display stage and the display updating stage.

Referring to FIG. 8A, in the present modified example, in the result reading stage, content icons are displayed sequentially in a manner that they are placed in one row from the left-hand side to the right-hand side of the display screen 400. In the example shown in FIG. 8A, there are displayed content icons 460a to 460e corresponding to pieces of content information, which are first to fifth in terms of display order, out of acquired pieces of content information.

FIG. 8B shows a display example of the display screen 400 in a state in which a predetermined time period has elapsed from the state shown in FIG. 8A. As shown in FIG. 8B, in the present modified example, when a predetermined number of content icons are placed in a line, the content icons are displayed sequentially in a manner that a content icon located at the leftmost position disappears and a content icon, which is next to be displayed in terms of display order, appears at the rightmost position of the line, and thus, the content icons move from right to left. In the example shown in FIG. 8B, a state is shown where the content icon 460e, which is fifth in terms of display order, disappears, and the content icon 460j, which is tenth in terms of display order, appears. Note that, in the present modified example, content icons may be displayed sequentially in a manner that they are placed in a line, and the direction of the line, the positions at which the content icons appear and disappear, and the direction in which the content icons move are not limited to the above example.

Referring to FIG. 8C, in the result display stage, content icons which are all of or a part of extraction results are placed in a line in accordance with display order. As shown in FIG. 8C, although only content icons 460a to 460f are displayed on one screen of the display screen 400, the content icons 460a to 460f may further be followed by other content icons which do not fit into the display screen 400 in the right direction of the screen. A scroll bar 480 may be displayed in the display screen 400, and by operating the scroll bar, the display of the display screen 400 is scrolled. In the display updating stage, the user scrolls the display of the display screen 400, and thus updating the display of extraction results and can check other content icons.

Heretofore, with reference to FIGS. 7A to 7C and FIGS. 8A to 8C, the description has been given on modified examples in which content icons are not displayed on a track placed around a region in the content information extraction GUI. In the present modified examples, in the result reading stage, content icons representing extraction results are displayed sequentially in a manner that they are placed in a tiled arrangement or in a line on the display screen 400. Accordingly, the user observes the display screen 400 in the result reading stage, and thereby being able to check the content icons which are displayed sequentially and to take a general view of the extraction results. Note that, in the present modified example, in the result reading stage, the display of color or the like of a content icon immediately before disappearing and/or a content icon immediately after having been appeared may be different from the display of color or the like of other content icons. Further, in the result reading stage, the sizes of the content icons may be changed in accordance with display order. For example, content icons may be displayed in a manner that the sizes thereof gradually decrease as the numbers representing the display order are smaller among the content icons displayed in the display screen 400, that is, as the content icons approach the position at which an arrived content icon disappears. Further, for example, content icons may be displayed in a manner that the sizes thereof gradually decrease only in a predetermined block from the position at which a content icon disappears, and may be displayed in a manner that the content icons move in substantially the same size in a block other than the predetermined block. In this way, content icons are displayed so that the following information becomes visually clear for the user: that a content icon is immediately after having been appeared; that a content icon is immediately before disappearing; and/or display order of content icons. Accordingly, the user observing the display can understand more easily and in more detail the display stages of the content information extraction GUI, and thus, the user's viewability with respect to the extraction results is further enhanced.

### 3. PROCEDURES OF INFORMATION PROCESSING METHOD

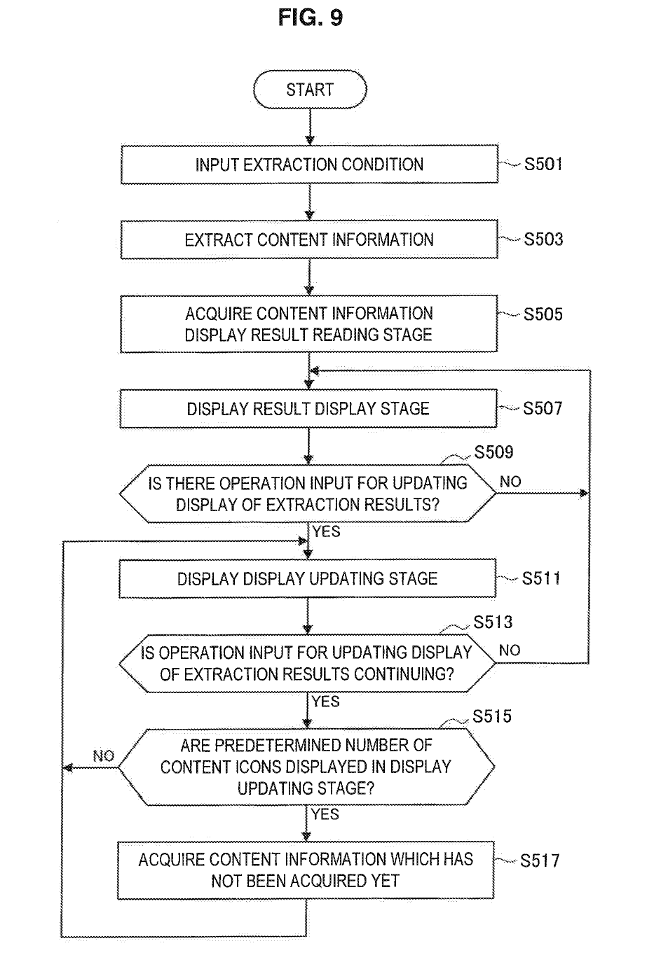

Next with reference to FIG. 9, the description will be given on procedures of an information processing method according to an embodiment of the present disclosure. FIG. 9 is a flowchart showing procedures of an information processing method according to an embodiment of the present disclosure. Note that the processes of the respective steps in the flowchart of the FIG. 9 may be achieved by the respective functions of the server 100 and the client 200 which have been described in the above “1. Configuration of content distribution system”.

Referring to FIG. 9, first, in Step S501, an extraction condition used for extracting content information is input. Specifically, the input of the extraction condition is performed by a user via the operation part 220 of the client 200. For example, the input of the extraction condition may include entering a search string into the search string entry field 420, or may include selecting any one of the extraction condition icons 430a to 430c each representing an extraction condition.

Next, in Step S503, pieces of content information are extracted based on the input extraction condition. Specifically, the content information extraction part 131 of the server 100 extracts pieces of content information from the content provider 50, which is a content distribution server, for example, based on the extraction condition.

Next, in Step S505, the extracted pieces of content information are acquired. Specifically, the content information acquisition part 253 of the client 200 acquires the pieces of content information extracted by the server 100. Note that all of the extracted pieces of content information may not necessarily be acquired at one time, and a predetermined number of pieces of content information may be acquired, for example. The number of pieces of content information that may be acquired at one time is limited to a predetermined number, and thus, an amount of information to be processed by the client 200 can be reduced.

Further, in Step S505, while pieces of content information are being acquired, the display part 230 of the client 200 displays, by the control performed by display controller 254, the result reading stage of the content information extraction GUI. In the result reading stage, as described above, content icons are displayed sequentially in a manner that the content icons move on the first track at predetermined intervals. Since the specific examples of the display screen in the result reading stage are described in the above “2-1. Display examples” and “2-3. Modified examples”, the detailed description will be omitted. Note that, as described above, the time period for which the display of the result reading stage is performed in the display part 230 of the client 200 may not correspond to the time period for which the content information acquisition part 253 actually acquires the pieces of content information. The time period for which the display of the result reading stage is performed may be appropriately set to a time period for which the user can visually recognize the content icons displayed sequentially.

After the result reading stage is displayed for a predetermined time period, the display part 230 of the client 200 displays, by the control performed by the display controller 254, the result display stage of the content information extraction GUI (Step S507). In the result display stage, as described above, a predetermined number of content icons are displayed on the second track at predetermined intervals. Since the specific examples of the display screen in the result display stage are described in the above “2-1. Display examples” and “2-3. Modified examples”, the detailed description will be omitted.

Next, in Step S509, it is determined with respect to the display of the content information extraction GUI in the result display stage whether there is an operation input for updating the display of extraction results. The operation input for updating the display of extraction results may be an operation input of moving an operation icon on the perimeter of the region 410 shown in FIGS. 2A to 2C and 4A to 6C, for example. Further, for example, as shown in FIGS. 8A to 9C, in the case where content icons are placed in a tiled arrangement or in a line, the operation input for updating the display of extraction results may be an operation of scrolling the display of content icons placed in a tiled arrangement or in a line. In the case where it is determined that there is no operation input for updating the display of extraction results, the display of the display screen does not change from the display of the result display stage. On the other hand, in the case where it is determined that there is an operation input for updating the display of extraction results, the processing proceeds to Step S511.

In Step S511, the display part 230 of the client 200 displays, by the control performed by the display controller 254, the display updating stage of the content information extraction GUI. In the display updating stage, as described above, the content icons are displayed sequentially in a manner that the content icons move on the first track at predetermined intervals in accordance with an operation input performed by a user. For example, the content icons may be displayed sequentially in a manner that the content icons move on the first track in accordance with the movement direction and the movement distance of the operation icon on the perimeter of the region 410. Since the specific examples of the display screen in the display updating stage are described in the above “2-1. Display examples” and “2-3. Modified examples”, the detailed description will be omitted.

Next, in Step S513, it is determined whether the operation input for updating the display of extraction results performed in Step S509 is continuing. In the case where it is determined that the operation input is interrupted, the processing returns to Step S507, and the display of the display screen returns to the display of the result display stage. However, when the display returns from the display updating stage to the result display stage, the result display stage may be displayed in the state that the movement of content icons in the display updating stage is reflected. Specifically, in the result display stage, content icons, which are displayed on the display screen at the moment of the operation input is interrupted in the display updating stage, may be displayed at predetermined intervals on the second track. In the case where the operation input for updating the display of extraction results is performed again in this state, in the display updating stage, the content icons can be moved from their latest state. On the other hand, in the case where it is determined that the operation input is continuing, the display of the display updating stage is maintained, and the content icons are displayed sequentially in a manner that the content icons move on the first track in accordance with the operation input performed by the user.

In Step S515, it is determined, while the display of the display updating stage is continuing and the content icons are sequentially moving on the first track in accordance with the operation input performed by the user, whether a predetermined number of content icons are displayed on the display screen. For example, the display controller 254 may be capable of counting the number of content icons displayed on the display screen out of acquired content icons, and may provide the content information acquisition part 253 with information about the counted number. Here, the content icons displayed on the display screen may be content icons that have passed through a third point, the third point being a predetermined point on the first track. The determination in Step S515 may be performed by the content information acquisition part 253 which has acquired the information. In the case where it is determined that the predetermined number of content icons are not displayed, the display of the display updating stage is continued. On the other hand, in the case where it is determined that the predetermined number of content icons are displayed, the processing proceeds to Step S517.

In Step S517, the content information acquisition part 253 reacquires content information. Specifically, the content information acquisition part 253 acquires pieces of content information, which have not been acquired yet, out of the pieces of content information extracted by the server 100. Further, while the content information acquisition part 253 is acquiring the pieces of content information which have not been acquired yet, the display part 230 continues the display of the display updating stage. In this way, in the case where the predetermined number of content icons are displayed in the display updating stage, the pieces of content information which have not been acquired yet are acquired automatically by the content information acquisition part 253, and thus, content icons serving as extraction results are continuously displayed sequentially without causing the user to wait, and viewability of the extraction results when the user checks the extraction results is further enhanced.

### 4. EXAMPLES OF APPLICATIONS

Next, the content distribution system 10 according to the present embodiment will be described in more detail. Here, the display screens of the content information extraction GUI shown in FIGS. 2A to 2E and 4A to 6C described above are each an example of a home screen at the time of activating an application of the content distribution system 10. In the content distribution system 10, by selecting a content icon in the home screen, a display screen of the content playback GUI is displayed on the display part 230 of the client 200, and content corresponding to the content icon is played back. Further, in the content distribution system 10, tag information can be associated with content. The content is played back in the content playback GUI, and the tag information is also displayed. The processing of associating the tag information with the content playback GUI and the content will be described in detail.

### 4-1. OVERVIEW OF CONTENT DISTRIBUTION SYSTEM

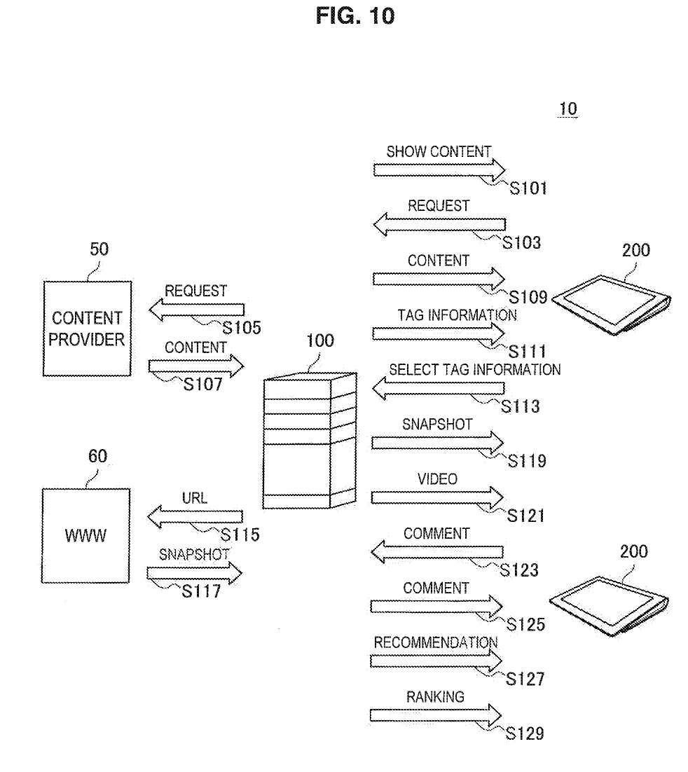

FIG. 10 is a diagram illustrating an overview of a content distribution system 10 according to an embodiment of the present disclosure. Referring to FIG. 10, the content distribution system 10 according to the present embodiment includes a server 100 and a client 200. The content distribution system 10, the server 100, and the client 200 correspond to the content distribution system 10, the server 100, and the client 200, which are shown in FIG. 1. The server 100 and the client 200 are connected to each other via the communication part 110 and the communication part 210 described above, through various types of wired or wireless networks.

First, the server 100 shows pieces of viewable content to the client 200 (S101). The showing of content may be displaying a display screen of a content information extraction GUI on the display part 230 of the client 200. A user of the client 200 selects content that the user wants to view from the pieces of content that have been shown, and transmit a request to the server 100 (S103). The selection of content may be selecting a content icon displayed on the content information extraction GUI. The server 100 which has received the request transfers the request to the content provider 50 such as a video distribution server (S105), and acquires content requested by the user of the client 200 (S107).

In providing the client 200 with the content acquired from the content provider 50 (S109), the server 100 also provides the client 200 with tag information (S111). The tag information is information generated by the server 100, for example, based on an activity of the user of the client 200 or another user who has viewed the same content, and is associated with at least a playback position of the content. Further, the tag information may be associated with a position inside the playback screen of the content. The activity of the user used here may be, for example, posting a comment during content playback, executing a web search, and viewing other content such as a photograph and a video. In the present embodiment, the tag information generated based on the user activity is displayed with the content. The user of the client 200 selects tag information, and thus can easily access information related to the content and know the reactions of other users with respect to the content, for example.

In the case where any one of pieces of tag information is selected by the user of the client 200 (S113), the server 100 accesses a world wide web (WWW) 60 using a uniform resource locator (URL) included in the selected tag information, for example (S115), and acquires a snapshot in a web page (S117). The acquired snapshot is transmitted to the client 200 (S119). Further, in the case where a comment of another user and another piece of content (for example, video content) is included in the tag information, the server 100 also provides the client 200 with those pieces of information (S121).

Further, the user of the client 200 can enter a comment with respect to the content (S123). The server 100 further generates tag information based on a new comment received from the client 200. In addition, the following may also be transmitted to the server 100 in the same manner as the comment: results of another activity with respect to the content such as a web search executed with respect to details of the content performed by the user of the client 200; and information such as viewing of other content performed by the user of the client 200. The server 100 generates new tag information based on those pieces of information, and additionally associates the new tag information with the content.

Further, the server 100 may also provide the client 200 with, in addition to the provision of the content itself, information such as a comment and a recommendation of another user and a ranking (S125 to S129). Those pieces of information can allow the user of the client 200 to easily select content to view, for example.

### 4-2. SPECIFIC EXAMPLES OF CONTENT PLAYBACK GUI

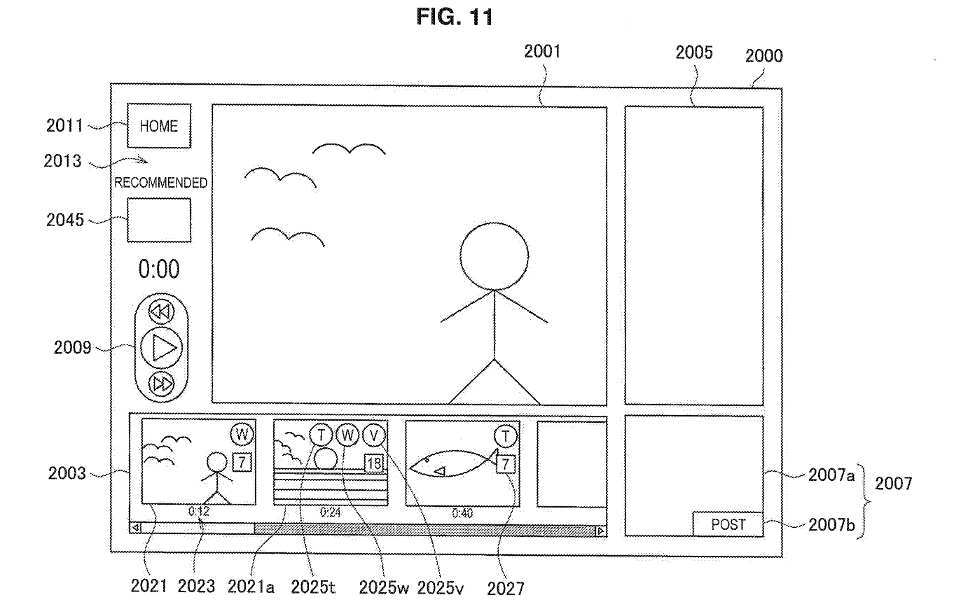

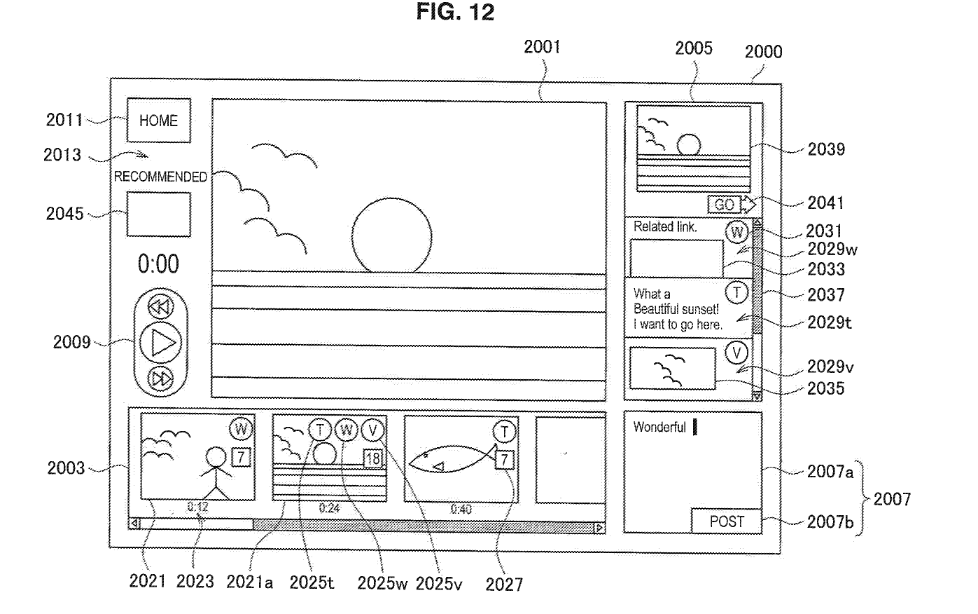

With the processing shown in Step S109 of FIG. 10, a display screen of a content playback GUI is displayed on the display part 230 of the client 200. The user can view content provided by the server 100 along with tag information by using the content playback GUI. With reference to FIG. 11 and FIG. 12, display examples of a content playback GUI will be described. FIG. 11 and FIG. 12 are each a diagram showing a display example of a content playback GUI according to the present embodiment. Note that various display controls in the content playback GUI are performed by the display controller 254.

Referring to FIG. 11, a display screen 2000 of the content playback GUI displays a content image 2001, a tag list display 2003, a tag details display 2005, a comment entry field 2007, a playback controller 2009, a home button 2011, and recommended information 2013.

The content image 2001 is a content image displayed based on data related to content transmitted by the server 100 to the client 200. In the example shown in the figure, the content is a video, but the content may also be content that does not include an image, such as music. In that case, displayed as the content image 2001 may be a picture image provided by the server 100 in correlation with the music content or a visual effect image generated by the server 100 or the client 200, and the display screen 2000 may not include the content image 2001.

The tag list display 2003 displays a list of pieces of tag information associated with content being played back, that is, associated with content being displayed as the content image 2001 in the example shown in the figure. In the present embodiment, data for displaying a list of pieces of tag information is provided by the server 100. The server 100 may provide as the tag information, in addition to the tag information that has already been generated, tag information that is newly associated with the content. Accordingly, in the case where new tag information is associated with the content based on an activity of a user who is viewing the content on the display screen 2000 or another user, the tag list display 2003 may be dynamically changed to a display including new tag information based on the new tag information provided by the server. More specifically, for example, a type icon 2025, which will be described later, may be added, or a number shown in a tag count 2027 within the group may gradually increase.

In the example shown in the figure, in the tag list display 2003, displayed as an icon showing the tag information is a captured image 2021 of the content at a playback position associated with each piece of tag information. The captured image 2021 may be displayed as a time stamp 2023 showing a corresponding playback position. Further, a type icon 2025 of the tag information may be added to the captured image 2021. In the example shown in the figure, the tag information may include text (type icon 2025t), a link to a web page (type icon 2025w), and/or a link to other content (type icon 2025v). With the display of the type icon 2025, the user can easily identify what type of information each piece of tag information includes.

Further, in the example shown in the figure, in the tag list display 2003, icons are displayed in a group when the icons each showing tag information are associated with playback positions close to each other. In this case, the display of the tag count 2027 within the group may be added to the captured image 2021. For example, in the case where a captured image 2021a having a time stamp 2023 of “0:24” has a display of “18” as the tag count 2027 within the group, it is identified that the number of pieces of tag information associated with playback positions close to this playback position is 18. In the case where the pieces of tag information are grouped in this way, a plurality of type icons 2025 may be added to the captured image 2021. For example, in the captured image 2021a described above, the type icons 2025t, 2025w, and 2025v are displayed, and hence, it is identified that the text, the link to a web page, and the link to other content are included in 18 pieces of tag information.

The tag details display 2005 individually displays, when an icon of tag information displayed in the tag list display 2003 is selected, pieces of tag information that are grouped along with the tag information. In the present embodiment, data used for displaying the tag details display 2005 may also be provided by the server 100 in the same manner as the the list display 2003. As described above, the server 100 may provide, in addition to the existing tag information, tag information newly associated with the content. Accordingly, in the case where new tag information is generated based on an activity of a user who is viewing the content on the display screen 2000 or another user, the tag details display 2005 may be changed to a display including new tag information. More specifically, for example, tag information may be additionally displayed while the content is being played back.

Here, in the example shown in FIG. 11, since the user does not select an icon of tag information displayed in the tag list display 2003, the tag details display 2005 is blank. In this case, an advertisement or the like may be display instead of the tag details display 2005. On the other hand, in the example shown in FIG. 12, since the user selects the captured image 2021a displayed in the tag list display 2003, the pieces of tag information included in a group corresponding to the captured image 2021a are displayed as the tag details display 2005. In this case, a playback position of the content displayed as the content image 2001 may be jumped to the playback position (in the example of FIG. 12, time stamp “0:24”) of the selected tag information.

In the example shown in FIG. 12, the tag details display 2005 displays three tag information displays 2029t, 2029w, and 2029v including text, a web page, and other content, respectively. For identifying types of those pieces of tag information, a type icon 2031 similar to the type icon 2025 displayed in the tag list display 2003 may also be displayed.

In the tag information display 2029w including a link to a web page, a snapshot 2033 of the web page may be displayed. The snapshot 2033 has a link to the web page, and the user may be accessible to the web page by selecting the image of the snapshot 2033. Further, in the tag information display 2029v including other content, a thumbnail 2035 of the other content may be displayed. The thumbnail 2035 has a link for playing back the other content, and the user may be accessible to the other content by selecting the thumbnail 2035. In this case, the other content may be played back in a screen other than the display screen 2000, for example. According to another embodiment, in order to increase the number of tag information displays 2029 that can be displayed, the snapshot 2033 and the thumbnail 2035 may not be displayed at the start of the tag details display 2005, and the snapshot 2033 and the thumbnail 2035 may be displayed each as detailed information when tag information display 2029 is selected.

As described above, 18 pieces of tag information are included in the group corresponding to the captured image 2021a, and are not displayed at one time in the tag details display 2005 shown in the example illustrated in the figure. In this case, a scroll bar 2037 may be displayed in the tag details display 2005, and the tag information displays 2029 arranged in a vertical direction may be scrolled and viewed. The arrangement order of the tag information displays 2029 may be time series order, or may be order of popularity determined based on the number of accesses to the link to the web page or the content, for example. Further, in the case where new tag information is associated with the content, the new tag information may be added to the top or the bottom of the tag details display 2005.

Further, in the example shown in FIG. 12, after having jumped to the playback position of the selected tag information, the playback of the content is continued. Accordingly, in order to show what sort of scene the displayed tag information represents, the tag details display 2005 may include a captured image 2039 (in the example shown in FIG. 12, an identical image as the captured image 2021a). In addition, a jump button 2041 may be displayed with the captured image 2039. When the user selects the jump button 2041, the playback position of the content shown as the content image 2001 is jumped to the playback position corresponding to the captured image 2039, that is, the playback position corresponding to the tag information displayed as a tag details display 2005.

The comment entry field 2007 includes a text entry field 2007a and a post button 2007b, and accepts a comment posted by the user on the content being played back. The comment that has been posted using the comment entry field 2007 may be processed as a comment on a service provided by the server 100, or may be processed as a comment on other social media, for example. In any case, new tag information may be generated in the server 100 based on the posted comment, and the generated tag information may be associated with the content. In this case, the server 100 may detect the playback position of the content at the time when the posting of a comment is executed by selecting the post button 2007b or when the text entry field 2007a is selected and text entry is started, and may associate the generated tag information to the playback position. In the case where another piece of tag information has already been associated with a position near the playback position with which the tag information newly generated by the comment posted by the user is associated, a group of the tag information associated with the position near the playback position may be automatically displayed on the tag details display 2005 after user's comment posting.

The playback controller 2009 is a GUI component for controlling start and stop of playback of the content, moving of a playback position, and the like in the display screen 2000. The home button 2011 is a button for interrupting or finishing viewing of content and jumping to a home screen. The recommended information 2013 displays, for example, recommendations of content from a curator whom the user follows and another user belonging to the same group as the user. For example, by selecting a thumbnail 2045 of the content displayed as the recommended information 2013, the content displayed as the content image 2001 may be switched to the content displayed as the thumbnail 2045, and viewing of the content may be started.

Heretofore, with reference to FIG. 10, FIG. 11, and FIG. 12, an overview of the content distribution system according to the present embodiment and display examples of the content playback GUI have been described. Note that the server 100 and the client 200 may be configured so as to be able to achieve the process in each step shown in FIG. 10 and the various types of processes performed in the content playback GUI shown in FIG. 11 and FIG. 12. As for the configurations of the server 100 and the client 200 capable of achieving those processes, Japanese Patent Application No. 2013-095688 can be referred to, which is filed before the present application by the applicants of the present application, for example.

### 5. HARDWARE CONFIGURATION

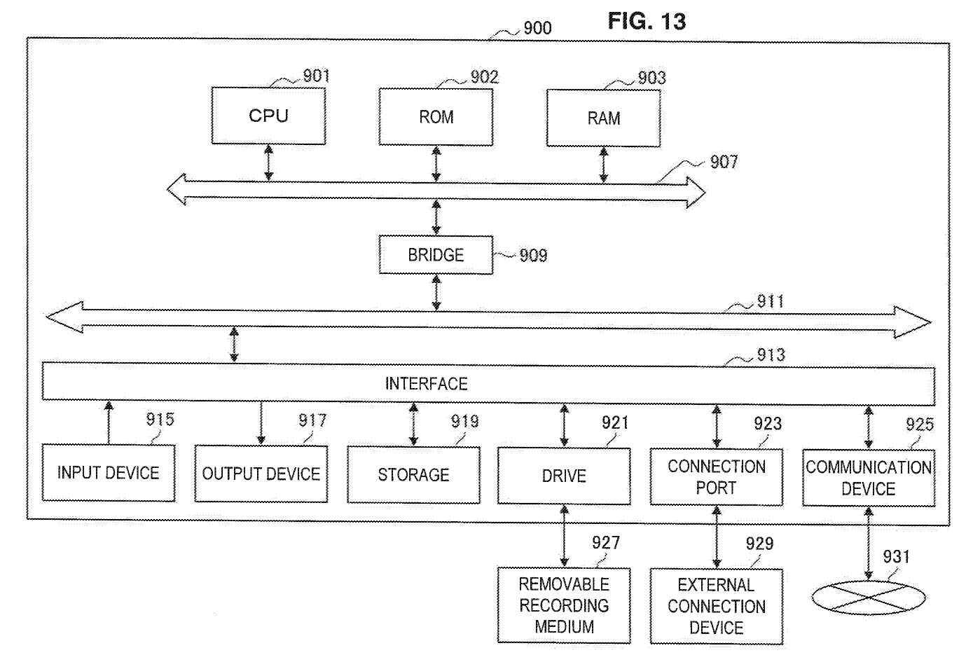

Next, with reference to FIG. 13, a hardware configuration of an information processing apparatus according to an embodiment of the present disclosure will be described. FIG. 13 is a block diagram showing a hardware configuration of an information processing apparatus. An information processing apparatus 900 shown in the figure may achieve the server 100, the client 200, or the like shown in FIG. 1, for example.

The information processing apparatus 900 includes a CPU 901, read only memory (ROM) 903, and random access memory (RAM) 905. Further, the information processing apparatus 900 may include a host bus 907, a bridge 909, an external bus 911, an interface 913, an input device 915, an output device 917, a storage 919, a drive 921, a connection port 923, and a communication device 925. The information processing apparatus 900 may have, instead of the CPU 901, or with the CPU 901, a processing circuit called a digital signal processor (DSP) or an application specific integrated circuit (ASIC).

The CPU 901 functions as an arithmetic processing apparatus and a control device, and controls the overall operation or a part of the operation of the information processing apparatus 900 according to various programs recorded in the ROM 903, the RAM 905, the storage 919, or a removable recording medium 927. The ROM 903 stores programs, operation parameters, and the like used by the CPU 901. The RAM 905 primarily stores programs used in execution of the CPU 901 and parameters and the like at the time of the execution. The CPU 901, the ROM 903, and the RAM 905 are connected with each other via the host bus 907 configured from an internal bus such as a CPU bus or the like. In addition, the host bus 907 is connected to the external bus 911 such as a peripheral component interconnect/interface (PCI) bus via the bridge 909. The CPU 901 corresponds to the controller 130 of the server 100 and the controller 250 of the client 200 according to the present embodiment, for example.

The input device 915 is a device operated by a user, such as a mouse, a keyboard, a touch panel, buttons, and a switch. The input device 915 may be a remote control device using, for example, infrared light or other radio waves, or may be an external connection device 929 such as a mobile phone compatible with the operation of the information processing apparatus 900. The input device 915 includes an input control circuit generating an input signal based on information input by a user and outputting the input signal to the CPU 901. The user can input various data to the information processing apparatus 900 and can instruct the information processing apparatus 900 to perform processing by operating this input device 915. The input device 915 corresponds to the operation part 220 of the client 200 according to the present embodiment, for example.

The output device 917 is configured from a device capable of notifying visually and aurally the user of acquired information. For example, the output device 917 may be a display device such as a liquid crystal display (LCD) or an organic electro-luminescence (EL) display, or an audio output device such as a speaker or headphones. The display device corresponds to the display part 230 of the client 200 according to the present embodiment, for example. The output device 917 outputs processing results of the information processing apparatus 900 as video such as text or an image and audio such as audio or sound.

The storage 919 is a device for storing data configured as an example of a storage of the information processing apparatus 900. The storage 919 is configured from, for example, a magnetic storage device such as a hard disk drive (HDD), a semiconductor storage device, an optical storage device, or a magneto-optical storage device. This storage 919 stores programs to be executed by the CPU 901, various types of data, and various types of data obtained from the outside. The storage 919 corresponds to the storage 240 of the client 200 according to the present embodiment, for example.

The drive 921 is a reader/writer for the removable recording medium 927 such as a magnetic disk, an optical disc, a magneto-optical disk, or semiconductor memory, and is embedded in or externally attached to the information processing apparatus 900. The drive 921 reads information recorded in the attached removable recording medium 927, and outputs the read information to the RAM 905. Further, the drive 921 writes the record in the attached removable recording medium 927. In the present embodiment, the drive 921 can read various types of information to be processed in the present embodiment from the removable recording medium 927 and can write the various types of information in the removable recording medium 927.

The connection port 923 is a port for allowing devices to directly connect to the information processing apparatus 900. The connection port 923 may be a universal serial bus (USB) port, an IEEE1394 port, a small computer system interface (SCSI) port, and the like. Further, the connection port 923 may also be an RS-232C port, an optical audio terminal, a high-definition multimedia interface (HDMI (registered trademark)) port and the like. The connection of the external connection device 929 to the connection port 923 enables exchanging of various types of data between the information processing apparatus 900 and the external connection device 929. In the present embodiment, the connection port 923 can transmit/receive various types of information to be processed in the present embodiment to/from the external connection device 929.

The communication device 925 is a communication interface configured from, for example, a communication device for establishing a connection to a communication network 931. The communication device 925 is, for example, a wired or wireless local area network (LAN), Bluetooth (registered trademark), a communication card for a wireless USB (WUSB), or the like. Alternatively, the communication device 925 may be a router for optical communication, a router for asymmetric digital subscriber line (ADSL), a modem for various communications, or the like. The communication device 925 can transmit/receive signals and the like to/from the Internet and with other communication devices using a predetermined protocol such as TCP/IP, for example. The communication network 931 connected to the communication device 925 is a network, which is connected via wire or wirelessly, and may be, for example, the Internet, a home-use LAN, infrared communication, radio wave communication, and satellite communication. The communication device 925 corresponds to the communication part 110 of the server 100 and the communication part 210 of the client 200 according to the present embodiment.

Heretofore, an example of the hardware configuration of the information processing apparatus 900 has been shown. Each of the structural elements described above may be configured using a general-purpose material, or may be configured from hardware dedicated to the function of each structural element. The configuration can be changed as appropriate according to the technical level at the time of carrying out embodiments.

### 6. SUPPLEMENT

Embodiments of the present disclosure may include, for example, the information processing apparatus, the system, the information processing method executed by the information processing apparatus or the system, a program for causing the information processing apparatus to operate, and a non-transitory tangible medium having the program recorded thereon.

It should be understood by those skilled in the art that various modifications, combinations, sub-combinations and alterations may occur depending on design requirements and other factors insofar as they are within the scope of the appended claims or the equivalents thereof.

For example, although the description has been given on the display control on the extraction results in the content distribution system in the above embodiments, the present technology is not limited thereto. The present technology can be applied to another system as long as it is a system that displays a plurality of pieces of information to a user. For example, the present technology may be applied to a display of search results obtained using a search engine of a web site, and a display of search results obtained by searching holders and files stored within a predetermined storage range.

Additionally, the present technology may also be configured as below.
(1) An information processing apparatus including:

a content information acquisition part configured to acquire pieces of content information extracted based on an extraction condition; and

a display controller configured to cause content icons corresponding to the pieces of content information, respectively, to be displayed on a track placed around a region,

wherein, in a first display stage, the display controller causes the content icons to be displayed sequentially on a first track in a manner that the content icons appear at a first point on the first track and disappear at a second point on the first track, the second point being different from the first point, and, in a second display stage, the display controller causes a predetermined number of the content icons corresponding to the pieces of content information, respectively, to be displayed on a second track.
(2) The information processing apparatus according to (1),

wherein the first track and the second track are different from each other.
(3) The information processing apparatus according to (2),

wherein the first track is a spiral track having the region as a center, and

wherein, in the first display stage, the display controller causes the content icons to be displayed in a manner that sizes of the content icons gradually increase as the content icons move from an inner part to an outer part on the spiral track.
(4) The information processing apparatus according to (2) or (3),

wherein the second track is a ring-shaped track, and

wherein, in the second display stage, the display controller causes each of the content icons to be displayed in a predetermined size on the ring-shaped track.
(5) The information processing apparatus according to (1),

wherein the first track and the second track are identical to each other.
(6) The information processing apparatus according to (5),

wherein the first track and the second track are each a ring-shaped track, and

wherein, in the first display stage and the second display stage, the display controller causes the content icons to be displayed in a predetermined size on the ring-shaped track.
(7) The information processing apparatus according to any one of (1) to (6),

wherein, in a result display stage in which a predetermined number of extraction results are displayed, the display controller causes the content icons to be displayed in the second display stage.
(8) The information processing apparatus according to any one of (1) to (7),

wherein, in a result reading stage showing that an extraction result is newly acquired and in a display updating stage in which a display of an extraction result is updated, the display controller causes the content icons to be displayed in the first display stage, and also causes the content icons to be displayed sequentially in a manner that the content icons move on the first track at predetermined intervals.
(9) The information processing apparatus according to (8),

wherein, in the result reading stage, the first track is a spiral track having the region as a center, and

wherein, on the spiral track, the first point and the second point are located such that a distance between the first point and the center is shorter than a distance between the second point and the center.
(10) The information processing apparatus according to (8), further including

an operation information acquisition part configured to acquire operation information that is information about an operation input performed by a user,

wherein, in the display updating stage, the display controller causes the content icons to be displayed sequentially in a manner that the content icons move on the first track in accordance with the operation information.
(11) The information processing apparatus according to (10),

wherein the operation information includes information about a movement distance and a movement direction of an operation icon on a perimeter of the region, and

wherein, in the display updating stage, the display controller causes the content icons to be displayed sequentially in a manner that the content icons move on the first track in accordance with the movement distance and the movement direction of the operation icon.
(12) The information processing apparatus according to (10) or (11),

wherein, in the display updating stage, in a case where the display controller causes a predetermined number of content icons to be displayed in a manner that the content icons pass through a third point on the first track, the content information acquisition part acquires one or more pieces of content information, which have not been acquired yet, out of the extracted pieces of content information.
(13) The information processing apparatus according to any one of (1) to (12),

wherein, in a case where a plurality of users share pieces of content corresponding to the pieces of content information,
the pieces of content information include pieces of information about the users associated with the pieces of content, and
in the second display stage, the display controller further causes icons showing the users associated with the pieces of content to be displayed in a manner that the icons showing the users are associated with content icons corresponding to the pieces of content.
(14) The information processing apparatus according to (13),

wherein the extraction condition used for extracting the pieces of content information includes that the pieces of content information are associated with a specific user out of the plurality of users.
(15) The information processing apparatus according to any one of (1) to (14),

wherein the region has a shape of one of a circle and an ellipse.
(16) The information processing apparatus according to any one of (1) to (15),

wherein the display controller causes a total number of the pieces of content information acquired by the content information acquisition part and a number of content icons passed through a third point on the first track to be displayed in the region.
(17) The information processing apparatus according to any one of (1) to (15),

wherein the display controller causes an icon showing the extraction condition used for extracting the pieces of content information to be displayed in the region.
(18) An information processing method including:

acquiring pieces of content information extracted based on an extraction condition;

causing content icons corresponding to the pieces of content information, respectively, to be displayed on a track placed around a region;

causing, in a first display stage, the content icons to be displayed sequentially on a first track in a manner that the content icons appear at a first point on the first track and disappear at a second point on the first track, the second point being different from the first point; and

causing, in a second display stage, a predetermined number of the content icons corresponding to the pieces of content information, respectively, to be displayed on a second track.

What is claimed is:

1. An information processing apparatus comprising:
a content information acquisition part configured to acquire pieces of content information extracted based on an extraction condition; and
a display controller configured to cause content icons corresponding to the pieces of content information, respectively, to be displayed on a track placed around a region,
wherein, in a first display stage, the display controller causes the content icons to be displayed sequentially on a first track in a manner that the content icons appear at a first point on the first track and disappear at a second point on the first track, the second point being different from the first point, and, in a second display stage, the display controller causes a predetermined number of the content icons corresponding to the pieces of content information, respectively, to be displayed on a second track.

2. The information processing apparatus according to claim 1,
wherein the first track and the second track are different from each other.

3. The information processing apparatus according to claim 2,
wherein the first track is a spiral track having the region as a center, and
wherein, in the first display stage, the display controller causes the content icons to be displayed in a manner that sizes of the content icons gradually increase as the content icons move from an inner part to an outer part on the spiral track.

4. The information processing apparatus according to claim 2,
wherein the second track is a ring-shaped track, and
wherein, in the second display stage, the display controller causes each of the content icons to be displayed in a predetermined size on the ring-shaped track.

5. The information processing apparatus according to claim 1,
wherein the first track and the second track are identical to each other.

6. The information processing apparatus according to claim 5,
wherein the first track and the second track are each a ring-shaped track, and
wherein, in the first display stage and the second display stage, the display controller causes the content icons to be displayed in a predetermined size on the ring-shaped track.

7. The information processing apparatus according to claim 1,
wherein, in a result display stage in which a predetermined number of extraction results are displayed, the display controller causes the content icons to be displayed in the second display stage.

8. The information processing apparatus according to claim 1,
wherein, in a result reading stage showing that an extraction result is newly acquired and in a display updating stage in which a display of an extraction result is updated, the display controller causes the content icons to be displayed in the first display stage, and also causes the content icons to be displayed sequentially in a manner that the content icons move on the first track at predetermined intervals.

9. The information processing apparatus according to claim 8,
wherein, in the result reading stage, the first track is a spiral track having the region as a center, and
wherein, on the spiral track, the first point and the second point are located such that a distance between the first point and the center is shorter than a distance between the second point and the center.

10. The information processing apparatus according to claim 8, further comprising
an operation information acquisition part configured to acquire operation information that is information about an operation input performed by a user,
wherein, in the display updating stage, the display controller causes the content icons to be displayed sequentially in a manner that the content icons move on the first track in accordance with the operation information.

11. The information processing apparatus according to claim 10,
wherein the operation information includes information about a movement distance and a movement direction of an operation icon on a perimeter of the region, and
wherein, in the display updating stage, the display controller causes the content icons to be displayed sequentially in a manner that the content icons move on the first track in accordance with the movement distance and the movement direction of the operation icon.

12. The information processing apparatus according to claim 10,
wherein, in the display updating stage, in a case where the display controller causes a predetermined number of content icons to be displayed in a manner that the content icons pass through a third point on the first track, the content information acquisition part acquires one or more pieces of content information, which have not been acquired yet, out of the extracted pieces of content information.

13. The information processing apparatus according to claim 1,
wherein, in a case where a plurality of users share pieces of content corresponding to the pieces of content information,
the pieces of content information include pieces of information about the users associated with the pieces of content, and
in the second display stage, the display controller further causes icons showing the users associated with the pieces of content to be displayed in a manner that the icons showing the users are associated with content icons corresponding to the pieces of content.

14. The information processing apparatus according to claim 13,
wherein the extraction condition used for extracting the pieces of content information includes that the pieces of content information are associated with a specific user out of the plurality of users.

15. The information processing apparatus according to claim 1,
wherein the region has a shape of one of a circle and an ellipse.

16. The information processing apparatus according to claim 1,
wherein the display controller causes a total number of the pieces of content information acquired by the content information acquisition part and a number of content icons passed through a third point on the first track to be displayed in the region.

17. The information processing apparatus according to claim 1,
wherein the display controller causes an icon showing the extraction condition used for extracting the pieces of content information to be displayed in the region.

18. An information processing method comprising:
acquiring pieces of content information extracted based on an extraction condition;
causing content icons corresponding to the pieces of content information, respectively, to be displayed on a track placed around a region;
causing, in a first display stage, the content icons to be displayed sequentially on a first track in a manner that the content icons appear at a first point on the first track and disappear at a second point on the first track, the second point being different from the first point; and
causing, in a second display stage, a predetermined number of the content icons corresponding to the pieces of content information, respectively, to be displayed on a second track.
